(19) United States
(12) Patent Application Publication
(10) Pub. No.: US 2026/0210895 A1
(43) Pub. Date: Jul. 23, 2026

(54) SINGLE ELECTRODE CAPACITANCE SENSOR FOR MEASUREMENT OF LIQUID LEVEL, LIQUID VOLUME, PERMITTIVITY, AND LIQUID FLOW

(71) Applicant: University of Washington, Seattle, WA (US)

(72) Inventors: Jae-Hyun CHUNG, Seattle, WA (US); Shawn KIM, Seattle, WA (US); Zhongjie QIAN, Seattle, WA (US)

(73) Assignee: University of Washington, Seattle, WA (US)

(21) Appl. No.: 19/138,472

(22) PCT Filed: Dec. 12, 2023
(86) PCT No.: PCT/US2023/083560

§ 371 Date: Jun. 12, 2025

Related U.S. Application Data
(60) Provisional application No. 63/387,155, filed on Dec. 13, 2022.

(51) Int. Cl. G01N 27/22; G01F 1/58; G01F 23/263

(52) U.S. Cl. CPC G01N 27/226; G01F 23/263; G01F 1/584; G01N 27/221

(57) ABSTRACT

A system for measuring a capacitance of a liquid, including a container configured to hold the liquid, and a sensor disposed on a first side of the container, wherein there is a separation distance between the sensor and the container, the sensor including a single electrode applied with positive potential, a composite substrate comprising a template material, where the template material includes a plurality of insulating fibers, and a plurality of carbon nanotubes bonded to the insulating fibers forming a nanotube coating on the insulating fibers, where one edge of the composite substrate is tom, where the plurality of insulating fibers align along the tensile force and expand in an out-of-plane direction at the site of the tear, where the electrode is coupled to the nanotube coating at the site of the tear, and where self-capacitance is formed between the single electrode and an environmental ground with a fringing field.

### CROSS-REFERENCE TO RELATED APPLICATION

This application claims the benefit of U.S. Provisional Application No. 63/387,155 filed Dec. 13, 2022, the entire disclosure of which is hereby incorporated by reference.

### BACKGROUND

Liquid detection involving the measurement of liquid dielectric properties, level, and flow rate has been important for various daily, environmental, and industrial applications. As the need of real-time and simple liquid detection grows, there has been a growing demand for low-cost and user-friendly sensors for liquid profiling in a container or a pipe. Waveguide systems and resonance sensors have been frequently used in the detection of liquid dielectric properties. However, the methodological constraints including sample placement hinder the applications. Liquid level can be measured by pressure, optical, ultrasonic, or electrical sensors. A hydrostatic pressure sensor is an inexpensive option. Since the sensor requires contact to liquid, which can increase flow resistance, liquid contamination, and inconvenience in installation. Optical and ultrasonic sensors have been featured as noncontact sensors without the risk of contamination. Despite the benefits, these methods are expensive and error-prone due to external noise. Electrical sensors such as resistive and capacitive sensors can be a cost-effective option. However, the resistive sensors are only applicable to conductive liquid while requiring relatively high power. Capacitive sensors have been regarded as a promising instrument to detect the level of both conductive and insulating liquid with high sensitivity and low power requirement. The detection capability of dielectric constants could be an additional benefit.

To date, capacitive liquid detection has been studied for detecting liquid level, dielectric constants, and flow rate. Capacitive sensors are sensitive to the dielectric property and liquid level. Interdigitated electrodes (IDE) could be used to sensitively detect the degree of oil deterioration due to the varying dielectric constants. The sensitivity of 24 pF per unit dielectric constant could be achieved. However, conventional sensors were required to be immersed in oil, which hampered the non-contact applications. IDE was also utilized to detect the water content in soil with the accuracy of 5% of water content. A capacitive probe was developed to detect the different dielectric constants of liquid. However, the dynamic range was narrow, resulting in the signal saturation over 32 of a dielectric constant. Nevertheless, the aforementioned sensors could only detect the properties of the liquid near the sensor's surface. For liquid level detection, multiple sensors were required due to the limited coverage of an electric field, which was cumbersome for actual use.

Accordingly, capacitive sensors for liquid capacitance measurement are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, disclosed herein is a system for measuring a capacitance of a liquid, the system including a container configured to hold the liquid, and a sensor disposed on a first side of the container, where there is a separation distance between the sensor and the container, the sensor including a single electrode applied with positive potential, a composite substrate comprising a template material, where the template material including a plurality of insulating fibers, and a plurality of carbon nanotubes bonded to the insulating fibers forming a nanotube coating on the insulating fibers, where one edge of the composite substrate is torn, where the plurality of insulating fibers align along the tensile force and expand in an out-of-plane direction at the site of the tear, where the single electrode is coupled to the nanotube coating at the site of the tear, such that an electrical signal passes through the plurality of junctions at the site of the tear; and where self-capacitance is formed between the single electrode and an environmental ground with a fringing field.

In some embodiments, the container is formed from a hydrophilic or hydrophobic material. In some embodiments, the container is formed from a conductive or nonconductive material.

In some embodiments, the separation distance between the single electrode and the first container ranges from about 0.1 mm to 30.0 mm.

In some embodiments, the first side is a bottom of the container. In some embodiments, the environmental ground is located inside the container. In some embodiments, the environmental ground defines a penetration depth, and wherein the penetration depth is controlled by varying frequency and/or voltage magnitudes of the system.

In some embodiments, the system further including a capacitance to digital chip coupled to the sensor configured to generate an excitation frequency, and a microprocessor configured to measure the capacitance. In some embodiments, the sensor is immersed in liquid to measure liquid volume or liquid level. In some embodiments, the sensor is coated with a nonconductive layer, wherein the nonconductive layer is configured to dampen a sensitivity and obtain a linear capacitive response.

In some embodiments, the sensor is disposed above the first side of the container, and the first side of the container is a bottom, a side, or a top of the container. In some embodiments, the sensor is configured to measure a difference of liquid permittivity. In some embodiments, the electrode is formed from an electrically conductive material.

In another aspect, disclosed herein is a system for measuring a capacitance of a first liquid, the system including a first container configured to hold the first liquid, a reference container configured to hold a reference liquid, where there is a container separation distance between the first container and the reference container, a measurement circuit, including a first sensor disposed on a first side of the first container, where there is a first separation distance between the first sensor and the first container, the first sensor including a first electrode applied with a positive potential, a first composite substrate comprising a first template material, where the first template material includes a first plurality of insulating fibers, and a first plurality of carbon nanotubes bonded to the first insulating fibers forming a first nanotube coating on the first insulating fibers, where one edge of the first composite substrate is torn, where the first plurality of insulating fibers align along the tensile force and expand in an out-of-plane direction at the site of the tear, where the first electrode is coupled to the first nanotube coating at the site of the tear, such that an electrical signal passes through the plurality of junctions at the site of the tear; and where self-capacitance is formed between the single electrode and an environmental ground with a fringing field, and a reference sensor disposed on a first side of the reference container, where there is a second separation distance between the reference sensor and the reference container, the reference sensor including a reference electrode, a capacitance to digital chip convertor configured to generate an excitation frequency, and a microprocessor configured to measure a capacitance change, where the measurement circuit is configured to measure a differential capacitance measurement between the first electrode and the reference electrode.

In some embodiments, the reference sensor further includes a second composite substrate comprising a second template material, wherein the second template material includes a second plurality of insulating fibers, and a second plurality of carbon nanotubes bonded to the second insulating fibers forming a second nanotube coating on the second insulating fibers, where one edge of the second composite substrate is torn, where the second plurality of insulating fibers align along the tensile force and expand in an out-of-plane direction at the site of the tear; where the reference electrode is coupled to the nanotube coating at the site of the tear, such that an electrical signal passes through the plurality of junctions at the site of the tear.

In some embodiments, the first separation distance ranges from about 0.01 mm to 30 mm. In some embodiments, the second separation distance ranges from about 0.01 mm to 30 mm. In some embodiments, the container separation distance ranges from about 50 mm to 200 mm. In some embodiments, the first container and the second container are a hydrophobic material. In some embodiments, the first container and the second container are a non-conductive material. In some embodiments, the first side of the first container is a bottom of the first container, and the first side of the reference container is a bottom of the reference container.

In some embodiments, a diameter of the first container ranges from about 1 mm to 1000 mm. In some embodiments, the first container is configured to hold 0.001 μl to 100 liters of the first liquid. In some embodiments, the reference container holds a constant volume of the reference liquid.

In some embodiments, a sensitivity of the system ranges from about 1.4 fF/μl to 20.0 fF/mm. In some embodiments, a detection range of the system is about 0 to 1000 mm.

In yet another aspect, disclosed herein is a system for measuring a capacitance of a liquid, the system including a surface configured to contact the liquid, a sensor including a single electrode applied with positive potential, a composite substrate including a template material, wherein the template material includes a plurality of insulating fibers, and a plurality of carbon nanotubes bonded to the insulating fibers forming a nanotube coating on the insulating fibers, where one edge of the composite substrate is torn, induced by a unidirectional tensile force to the composite substrate, where the plurality of insulating fibers align along the tensile force and expand in an out-of-plane direction at the site of the tear, and where the single electrode is coupled to the nanotube coating at the site of the tear, such that an electrical signal passes through the plurality of junctions at the site of the tear, and where self-capacitance is formed between the single electrode and an environmental ground, and where when the liquid contacts the surface, the sensor senses a change in capacitance.

In some embodiments, the surface is glass. In some embodiments, the liquid is sprayed onto the surface.

In yet another aspect, disclosed herein is a liquid dispenser including a first reservoir configured to hold a first liquid, a first sensor, disposed on a first side of the first reservoir, where there is a first separation distance between the first sensor and the first reservoir, and where the first sensor includes a first electrode applied with a positive potential, a first composite substrate comprising a first template material, where the first template material includes a first plurality of insulating fibers, and a first plurality of carbon nanotubes bonded to the first insulating fibers forming a first nanotube coating on the first insulating fibers, where one edge of the first composite substrate is torn, where the first plurality of insulating fibers align along the tensile force and expand in an out-of-plane direction at the site of the tear, where the first electrode is coupled to the first nanotube coating at the site of the tear, such that an electrical signal passes through the plurality of junctions at the site of the tear; and where self-capacitance is formed between the single electrode and an environmental ground with a fringing field, a first tubing fluidly coupled to the first reservoir, a second sensor coupled to the first tubing, a reference reservoir configured to hold a reference liquid, a first reference sensor, disposed on a first side of the reference reservoir, where there is a second separation distance between the first reference sensor and the reference reservoir, a reference tubing fluidly coupled to the reference reservoir, and a second reference sensor coupled to the reference tubing, where the first sensor is configured to measure a change in volume of the first liquid in the first reservoir, the second sensor is configured to measure an amount of first liquid that passes through the first tubing, the first reference sensor is configured to measure a change in volume of the reference liquid in the reference reservoir, and the second reference electrode is configured to measure an amount of reference liquid that passes through the reference tubing.

In some embodiments, the first reservoir comprises a first graduation indicator, and the reference reservoir comprises a second graduation indicator. In some embodiments, the first and second graduation indicators are LEDs. In some embodiments, the first liquid is a carbonated liquid, or both the first liquid and the reference liquid are a carbonated liquid.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1C are examples of capacitance sensors configurations for sensing liquid levels, in accordance with the present technology;

FIGS. 2A-2C are example circuit diagrams for single electrode capacitive sensor systems, in accordance with the present technology;

FIG. 3A is a numerical model with electrical field streamlines, in accordance with the present technology;

FIG. 3B is electrical field streamlines in a nonconductive container without liquid, in accordance with the present technology;

FIG. 3C is an electrical field gradient of the model of FIG. 3B, in accordance with the present technology;

FIG. 3D is electrical field streamlines in a nonconductive container with a liquid, in accordance with the present technology;

FIG. 3E is an electrical field gradient of the model of FIG. 3D, in accordance with the present technology;

FIG. 3F is electrical field streamlines in a conductive container with a liquid, in accordance with the present technology;

FIG. 3G is an electrical field gradient of the model of FIG. 3F, in accordance with the present technology;

FIGS. 4A-4B are example experimental setups, in accordance with the present technology;

FIG. 4C is a graph of the change in capacitance compared to the water level based on the setup of FIG. 4A, in accordance with the present technology;

FIG. 4D is an example ground location of the capacitance sensor in the liquid, in accordance with the present technology;

FIG. 4E is a graph of the change in capacitance based on the volume of water in the container, in accordance with the present technology;

FIGS. 5A-5B are graphs showing the capacitance change with respect to a liquid dimension change, in accordance with the present technology;

FIG. 6A is an example differential measurement system for measuring a liquid level, in accordance with the present technology;

FIG. 6B is a graph of the comparison of simulation and experimental results, in accordance with the present technology;

FIG. 7A is a graph of the capacitance change of various nonconductive cups with respect to volume change, in accordance with the present technology;

FIG. 7B is a graph capacitance change for volume change after filling the bottom area, in accordance with the present technology;

FIG. 7C is a graph of sensitivity of single electrode CPC sensor in terms of liquid volume for various radius non-conductive containers, in accordance with the present technology;

FIG. 7D is a graph of sensitivity of single electrode CPC sensor in terms of liquid level for various radius non-conductive containers, in accordance with the present technology;

FIG. 7E is a graph of capacitance change with respect to liquid level for large diameter beakers, in accordance with the present technology;

FIG. 7F is a graph of capacitance change with respect to liquid volume for large diameter beakers, in accordance with the present technology;

FIG. 8 is a graph of the comparison of the results of the empirical model and experiments, in accordance with the present technology;

FIGS. 9A-9D are process diagrams of testing glass and Teflon plates by adding water droplets, in accordance with the present technology;

FIG. 9E is a graph of the comparison of capacitance changes of the glass and Teflon plates of FIGS. 9A-9D, in accordance with the present technology;

FIGS. 10A-10B are graphs of characteristics of the noise level of using an empty cup (FIG. 10A) and a water filled cup (FIG. 10B) as reference in differential measurements, in accordance with the present technology;

FIG. 11A shows a system set up for two differential measurements for measuring liquid level, in accordance with the present technology;

FIGS. 11B-11D are graphs showing the results of the three test sets, in accordance with the present technology;

FIG. 12A is an experimental configuration of a system for measuring a liquid level, in accordance with the present technology;

FIG. 12B is an image of the experimental configuration shown in FIG. 12A, in accordance with the present technology;

FIG. 12C is a graph of the ΔC with respect to liquid contents, in accordance with the present technology;

FIG. 12D is a graph of the ΔC with respect to the alcohol volume fraction, in accordance with the present technology;

FIG. 13 is a graph of the comparison of the resolution and detection range of the presented capacitive sensor in comparison to other capacitive sensors.

FIG. 14A-14B are images of an example liquid detection system with one spray of liquid on it, in accordance with the present technology;

FIGS. 15A-15D show single sprays of liquid onto an example liquid detection system and the resulting capacitance, in accordance with the present technology;

FIGS. 16A-16B are images of an example liquid detection system with multiple sprays of liquid on it, in accordance with the present technology;

FIG. 17 is a graph of the capacitance measurements of multiple sprays on the windshield liquid detection system, in accordance with the present technology;

FIG. 18 is a graph showing volume response versus surface area response of multiple sprays on the windshield liquid detection system, in accordance with the present technology; and

FIG. 19 is a graph of the flow rate of the sprays compared to the change in capacitance of multiple sprays on the windshield liquid detection system, in accordance with the present technology.

### DETAILED DESCRIPTION

In one aspect, a system for measuring a capacitance of a liquid, is disclosed, including a container configured to hold the liquid, and a sensor disposed on a first side of the container, wherein there is a separation distance between the sensor and the container, the sensor including a single electrode applied with positive potential, a composite substrate comprising a template material, wherein the template material includes a plurality of insulating fibers, and a plurality of carbon nanotubes bonded to the insulating fibers forming a nanotube coating on the insulating fibers, where one edge of the composite substrate is torn, where the plurality of insulating fibers align along the tensile force and expand in an out-of-plane direction at the site of the tear, where the single electrode is coupled to the nanotube coating at the site of the tear, such that an electrical signal passes through the plurality of junctions at the site of the tear, and where self-capacitance is formed between the single electrode and an environmental ground with a fringing field.

In some embodiments, the container is formed from a hydrophilic or hydrophobic material. In some embodiments, the container is formed from a conductive or nonconductive material.

In some embodiments, the separation distance between the single electrode and the first container ranges from about 0.1 mm to 2.0 mm. In some embodiments, the first side is a bottom of the container.

In some embodiments, the system further includes a capacitance to digital chip coupled to the sensor configured to generate an excitation frequency, and a microprocessor configured to measure the capacitance.

In some embodiments, the sensor is immersed in liquid to measure liquid volume or liquid level. In some embodiments, the sensor is coated with a nonconductive layer, wherein the nonconductive layer is configured to dampen a sensitivity and obtain a linear capacitive response. In some embodiments, the sensor is disposed above the first side of the container, where the first side of the container is a bottom of the container.

In some embodiments, the sensor is configured to measure a difference of liquid permittivity. In some embodiments, the sensor material is formed from an electrically conductive material.

In another aspect, a system for measuring a capacitance of a first liquid, is disclosed, including a first container configured to hold the first liquid, a reference container configured to hold a reference liquid, where there is a container separation distance between the first container and the reference container, a measurement circuit, including a first sensor disposed on a first side of the first container, where there is a first separation distance between the first sensor and the first container, the first sensor including a first electrode applied with a positive potential, a first composite substrate comprising a first template material, wherein the first template material includes a first plurality of insulating fibers, and a first plurality of carbon nanotubes bonded to the first insulating fibers forming a first nanotube coating on the first insulating fibers, where one edge of the first composite substrate is torn, where the first plurality of insulating fibers align along the tensile force and expand in an out-of-plane direction at the site of the tear, where the first electrode is coupled to the first nanotube coating at the site of the tear, such that an electrical signal passes through the plurality of junctions at the site of the tear, and where self-capacitance is formed between the single electrode and an environmental ground with a fringing field, and a reference sensor disposed on a first side of the reference container, where there is a second separation distance between the reference sensor and the reference container, the reference sensor including a reference electrode, a capacitance to digital chip convertor configured to generate an excitation frequency, and a microprocessor configured to measure a capacitance change, where the measurement circuit is configured to measure a differential capacitance measurement between the first electrode and the reference electrode.

In some embodiments, the reference sensor further includes a second composite substrate comprising a second template material, where the second template material includes a second plurality of insulating fibers, and a second plurality of carbon nanotubes bonded to the second insulating fibers forming a second nanotube coating on the second insulating fibers, where one edge of the second composite substrate is torn, where the second plurality of insulating fibers align along the tensile force and expand in an out-of-plane direction at the site of the tear, where the reference electrode is coupled to the nanotube coating at the site of the tear, such that an electrical signal passes through the plurality of junctions at the site of the tear.

In some embodiments, the first separation distance ranges from about 0.01 mm to 5.0 mm. In some embodiments, the second separation distance ranges from about 0.01 mm to 5.0 mm. In some embodiments, the container separation distance ranges from about 50 mm to 200 mm. In some embodiments, the first container and the second container are a hydrophobic material. In some embodiments, the first container and the second container are a non-conductive material. In some embodiments, the first side of the first container is a bottom of the first container, and the first side of the reference container is a bottom of the reference container.

In some embodiments, a diameter of the first container ranges from about 2 to 1000 mm. In some embodiments, the first container is configured to hold 0.001 ml to 100 liters of the first liquid. In some embodiments, the reference container holds a constant volume of the reference liquid. In some embodiments, a sensitivity of the system ranges from about 1.0 F/μl to 20.0 F/mm. In some embodiments, a detection range of the system is about 0 to 1000 mm.

In yet another aspect, a system for measuring a capacitance of a liquid, is disclosed, including a surface configured to contact the liquid, a sensor including a single electrode applied with positive potential, a composite substrate comprising a template material, wherein the template material including a plurality of insulating fibers, and a plurality of carbon nanotubes bonded to the insulating fibers forming a nanotube coating on the insulating fibers; where one edge of the composite substrate is torn, induced by a unidirectional tensile force to the composite substrate, where the plurality of insulating fibers align along the tensile force and expand in an out-of-plane direction at the site of the tear, and where the single electrode is coupled to the nanotube coating at the site of the tear, such that an electrical signal passes through the plurality of junctions at the site of the tear, and where self-capacitance is formed between the single electrode and an environmental ground, and where when the liquid contacts the surface, the sensor senses a change in capacitance.

In some embodiments, the surface is glass. In some embodiments, the liquid is sprayed onto the surface.

In another aspect, a liquid dispenser including a first reservoir configured to hold a first liquid, a first sensor, disposed on a first side of the first reservoir, wherein there is a first separation distance between the first sensor and the first reservoir, and wherein the first sensor includes a first electrode applied with a positive potential, a first composite substrate comprising a first template material, wherein the first template material includes a first plurality of insulating fibers, and a first plurality of carbon nanotubes bonded to the first insulating fibers forming a first nanotube coating on the first insulating fibers, where one edge of the first composite substrate is torn, where the first plurality of insulating fibers align along the tensile force and expand in an out-of-plane direction at the site of the tear, where the first electrode is coupled to the first nanotube coating at the site of the tear, such that an electrical signal passes through the plurality of junctions at the site of the tear, and where self-capacitance is formed between the single electrode and an environmental ground with a fringing field, a first tubing fluidly coupled to the first reservoir, a second sensor coupled to the first tubing, a reference reservoir configured to hold a reference liquid; a first reference sensor, disposed on a first side of the reference reservoir, where there is a second separation distance between the first reference sensor and the reference reservoir, a reference tubing fluidly coupled to the reference reservoir, and a second reference sensor coupled to the reference tubing, where the first sensor is configured to measure a change in volume of the first liquid in the first reservoir, the second sensor is configured to measure an amount of first liquid that passes through the first tubing, the first reference sensor is configured to measure a change in volume of the reference liquid in the reference reservoir, and the second reference electrode is configured to measure an amount of reference liquid that passes through the reference tubing.

In some embodiments, the first reservoir comprises a first graduation indicator, and the reference reservoir comprises a second graduation indicator. In dome embodiments, the first and second graduation indicators are LEDs. In some embodiments, the first liquid is a carbonated liquid, or both the first liquid and the reference liquid are a carbonated liquid.

In some embodiments, coplanar electrodes were used for capacitive sensors because of the higher fringing electric field. In some embodiments, capacitive electrodes were attached to the bottom or the side of liquid container for level measurement. For the lateral sensor placement, the electrodes were attached outside the wall of the container, where the capacitance increased as the liquid covered the larger area of the sensor. The resolution of 0.1 mm could be achieved. However, the larger electrodes were required to cover the whole lateral wall. For the bottom placement, the electrodes were placed outside and under the container to measure the liquid level and dielectric properties. IDE were developed and placed under a microfluidic device to measure the liquid level. Using the microgap between electrodes, three different dielectric liquid including distilled water, glycerol, and tetraethylene glycol could be differentiated. The dynamic range and the resolution of liquid level were 0~200 μm and 10 μm, respectively. According to the results, there was a trade between dynamic range and resolution, which was correlated to the electrode gap size. For example, the improved dynamic range of 0~1.5 mm reduced the resolution to 0.1 mm. Due to the fringing effect, a smaller electrode gap showed a higher sensitivity but a reduced dynamic range. A larger electrode gap showed a wider dynamic range but lowered sensitivity. Assuming a capacitive sensor made of a single electrode having an infinite gap size, the dynamic range could be much larger due to the diverging electrical field.

The capacitive sensors were also studied to measure a flow rate in a tube. According to the numerical simulation, laminar flow could shape a varying electrical double layer (EDL) due to a parabolic velocity profile, causing capacitance change. Orifice capacitive sensors were developed to measure flow rate. Various flow velocity profiles could generate different turbulent regions after passing the orifice. Since the dielectric constant in the turbulent region was smaller in comparison to the central region, the difference could be detected. However, the method was only applicable to high flow rate (~10 L/min). Also, monitoring two-phase flow (gas-liquid or solid-liquid) was intensively studied. Since the dielectric properties of the liquid and gas were significantly different, the sensors could measure the velocity of air bubbles to estimate liquid flow rate.

In one example, a liquid sensor made of carbon nanotubes-paper composite (CPC) is studied to measure the liquid level. This single electrode sensor was studied to investigate the capacitive interaction between liquid level and environment. The differential measurement configuration of liquid detection is studied to enhance sensitivity and stability. This capacitive sensor could rapidly and constantly detect the liquid level with high sensitivity in a non-contact manner. Moreover, this sensor could be applied to nonconductive and conductive containers, including glass and metal. The dynamic range and liquid level detection accuracy will be evaluated in the contexts of femtofarad level-accuracy of capacitance. In some embodiments, the single electrode configuration incorporating the simple form factor could be used in various applications, such as vending machine, water leak detector, rain detector, food processor, and industry automation.

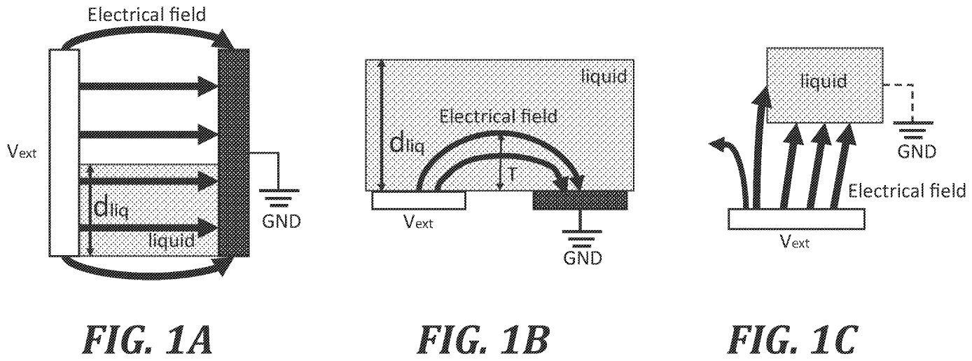

Turning now to the FIGURES, FIGS. 1A-1C are examples of capacitance sensors configurations for sensing liquid levels, in accordance with the present technology. In some embodiments, the capacitive sensor configuration for liquid level sensing was either parallel or co-planar. FIG. 1A shows a parallel capacitor for liquid level detection. In the parallel setup, the electrode dimension was the same as the container dimension to cover the full range of the liquid level. Although only one pair of electrodes could cover the level, the resolution was compromised.

FIG. 1B shows a co-planar capacitor and a dynamic range. As for co-planar placement, two electrodes were placed in a very small gap where the high electric field was generated due to the fringe effect. In this configuration, the penetration depth (T) of a co-planar capacitor was calculated with equation (1). Within the range of T, the liquid level was able to be detected accurately. However, the depth depending on the small gap size could limit the dynamic range.

$$\begin{matrix}T = asinh [ {cosh}^{- 1} ( 1 + \frac{w}{a} ) ] \\ = a \sqrt{{( 1 + \frac{w}{a} )}^{2} - 1}\end{matrix} \qquad Equation ( 1 )$$

As the gap size increased, T increased with reduction of the accuracy. Without losing accuracy, the dynamic range of water level could be improved by employing an array of electrodes or interdigitated electrodes. However, such measurement configuration was not suitable for industrial and commercial applications. To address this challenge, a single electrode that was made of carbon nanotube paper composite (CPC) was developed (FIG. 1C).

FIG. 1C shows a self-capacitance measurement using a single electrode. A single electrode may be used a self-capacitive system. When one electrode is used, the capacitance change is measured with respect to the surrounding ground. Considering the conventional capacitor composed of excitation- and grounded electrodes, a single electrode is an excitation source and the other electrode is regarded as ground or liquid. If liquid is supplied, the capacitance would increase. When a single electrode is employed, the theoretical penetration depth becomes infinite according to equation (1). The CPC electrodes were fabricated from tensional fracture. The fractured electrodes created an array of cantilever-shaped electrodes mimicking interdigitated electrodes (IDE). The high aspect ratio structure created a large surface area to enhance the fringing electric field and thus the capacitive sensitivity.

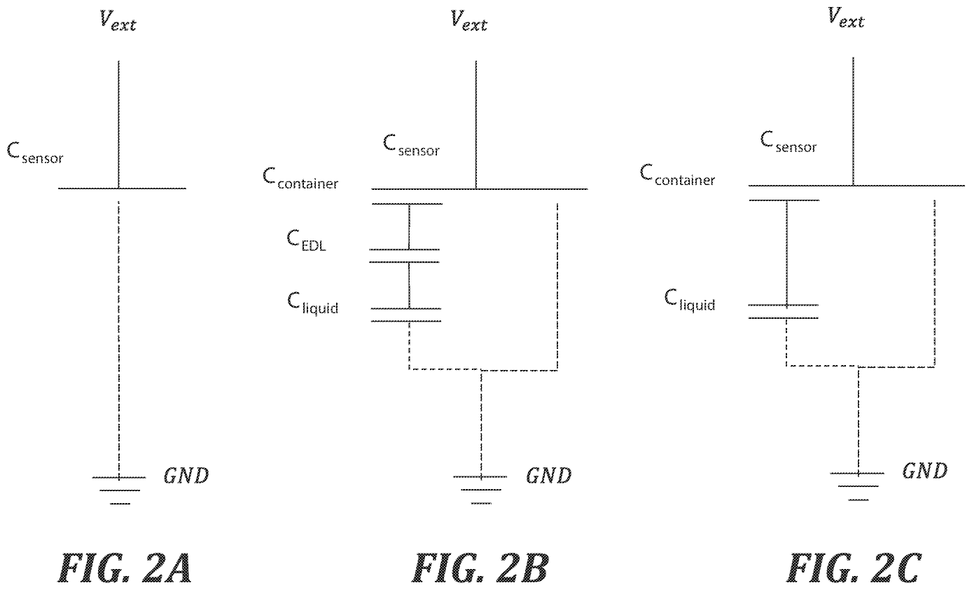

FIGS. 2A-2C are example circuit diagrams for single electrode capacitive sensor systems, in accordance with the present technology. For liquid level detection, the single electrode self-capacitance measurement was modeled in FIGS. 2A-2C.

FIG. 2A shows a single electrode capacitance sensor without an object. In some embodiments, the sensor is powered by the excitation voltage and the initial capacitance is determined with surrounding ground that is expressed with the dotted line.

FIG. 2B shows a sensor with a container and liquid. Liquid introduction in the container increased the initial interaction between the sensor and surrounding ground by adding a series of capacitors into the system. The mathematical model is expressed in equation 2, as:

$$C = {C}_{self} = \frac{1}{\frac{1}{{C}_{container}} + \frac{1}{{C}_{EDL}} + \frac{1}{{C}_{liquid}}} \qquad Equation ( 2 )$$

where C, C_{EDL}, and C_{self} are the capacitances of liquid, electrical double layer, and self-capacitance. The self-capacitance forms between the excitation electrode and the environmental ground. Considering the thickness of the electrical double layer 1~100 nm, the large capacitance of C_{EDL} could be eliminated in the serial capacitances.

FIG. 2C shows a simplified sensing model of liquid in a container. The simplified capacitance configuration is shown in FIG. 2C.

In one example, for a single electrode capacitor, the electric field distribution through liquid was studied by numerical analysis. The capacitance change, ΔC=(C₁−C₀) was used as a parameter, where C₁ and C₀ were the capacitances with and without liquid, respectively. Both containers made of non-conductive glass- and conductive stainless steel were modeled to study the electric field and the resulting capacitance change. The sensor was modeled as a rectangular shaped metal plate with the dimensions of 5×5×1 mm³. The gap size between the sensor and the container was 1 mm. In some embodiments, the gap size (or separation distance) is about 0.01 mm to 5.0 mm. Two numerical models were constructed to investigate the sensing mechanism of liquid in the conductive and non-conductive containers, respectively.

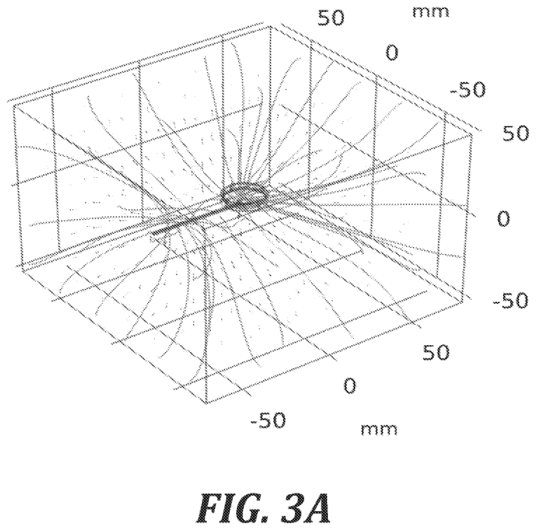

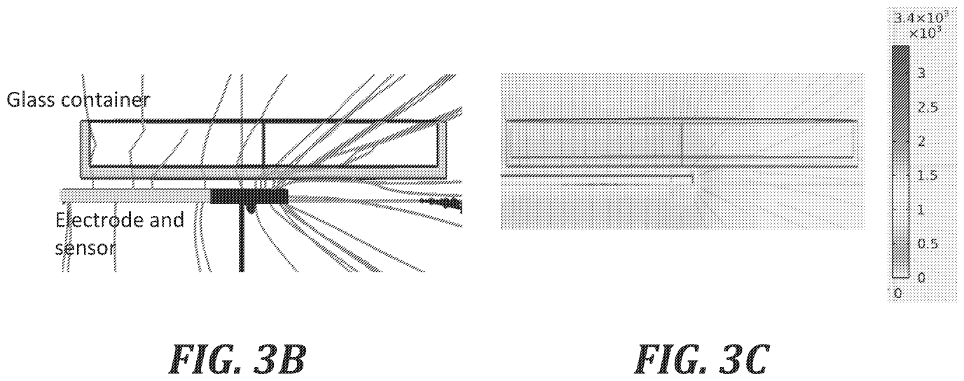

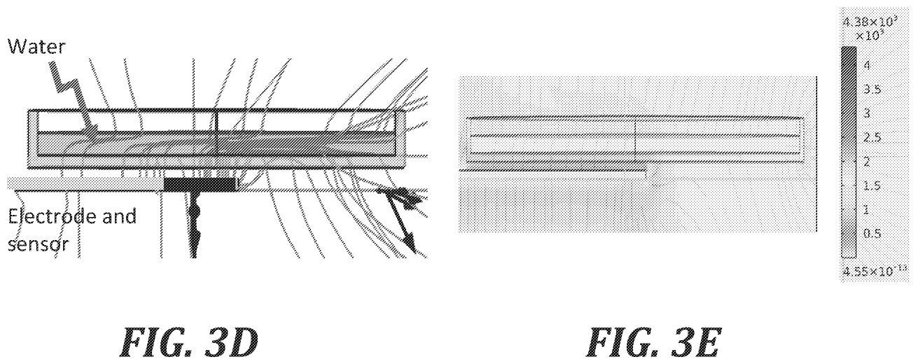

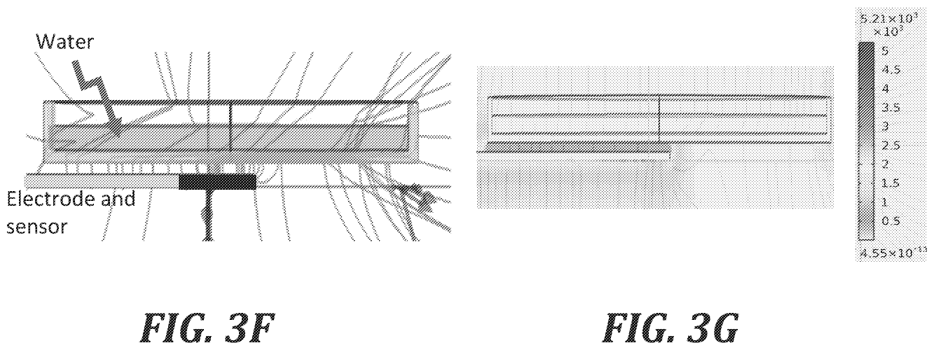

The first test was to investigate how the liquid in the non-conductive container contributed to ΔC in the single electrode capacitive sensor. FIG. 3A is a numerical model with electrical field streamlines, in accordance with the present technology. FIG. 3B is electrical field streamlines in a nonconductive container without liquid, in accordance with the present technology. FIG. 3C is an electrical field gradient of the model of FIG. 3B, in accordance with the present technology. FIG. 3D is electrical field streamlines in a nonconductive container with a liquid, in accordance with the present technology. FIG. 3E is an electrical field gradient of the model of FIG. 3D, in accordance with the present technology. FIG. 3F is electrical field streamlines in a conductive container with a liquid, in accordance with the present technology. FIG. 3G is an electrical field gradient of the model of FIG. 3F, in accordance with the present technology. In the numerical model, a liquid container was modeled with a varying diameter from 20 mm to 160 mm with the increment of 20 mm as shown in FIG. 3A. The container was encapsulated in a grounded cube with the 100 mm length. When liquid was supplied to the container, the liquid level was 2 mm. In practice, the initial liquid level could not be accurately controlled due to the contact angle. The water level of 2 mm assumed to have a minimal height of liquid in an open container. The relative permittivity of the liquid was 80, assuming pure water. A 5V-AC potential at 10 KHz frequency was applied on the electrode.

Without liquid, the electric field fringed from the sensor as well as the wire to the grounded box was plotted for the 3-dimensional model in FIG. 3A. Without liquid, the electric field diverged to the surrounding ground (FIGS. 3B-3C). When liquid was introduced, the electrical paths originated from the facing surface of the sensor were shifted to the liquid that increased ΔC (FIGS. 3D-3E). It was found that the electric field strength between water and sensor was higher and decayed toward the grounded cage. The introduced liquid in the non-conductive container performed as another electrode that interacted with the sensor and the ground. Without liquid, the capacitance formed between the single electrode and the ground with the negligible effect from the container size. When liquid was supplied, the capacitance increased with the increase of the container diameter.

The simulation for conductive container liquid test was conducted with the stainless-steel container of 40 mm-diameter. To estimate ΔC, the C₀ of empty stainless-steel cup was located on the single electrode. Since the steel cup has high conductance, numerical study was conducted for the different liquid levels in the cup. ΔC was computed using the different water levels.

According to the electric field distribution in FIGS. 3F and 3G, the capacitance formed between the empty metal cup and the sensor electrode. The ΔC from the additional liquid could be negligible due to the high conductance of steel container.

As described herein, the single-ended capacitive sensor was made of carbon nanotube paper composites (CPC). In short, the sensor was fabricated by trimming the CPC material to 10×5 mm² shape. Through the wet-stretching method, the 5×5 mm² fibrous pieces of CPC were fabricated.

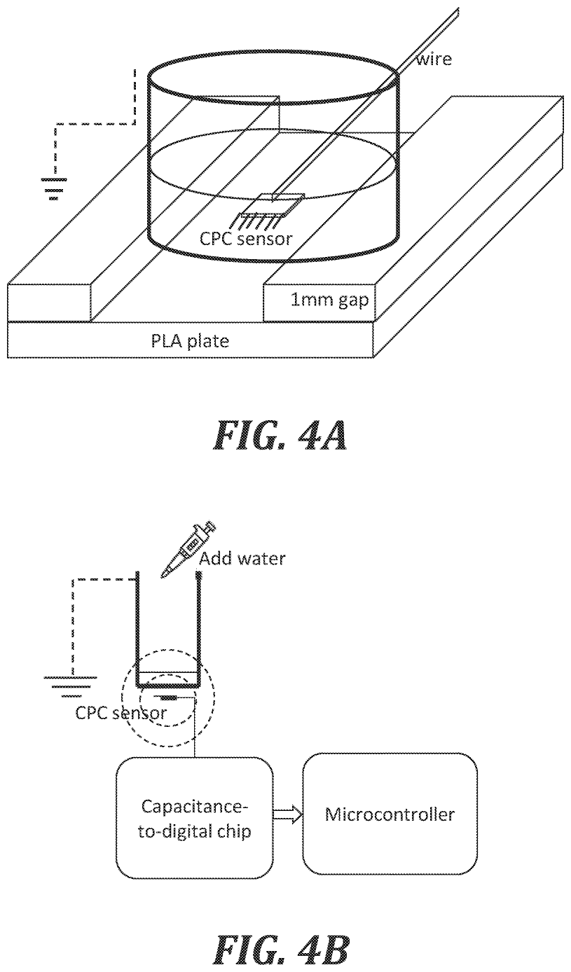

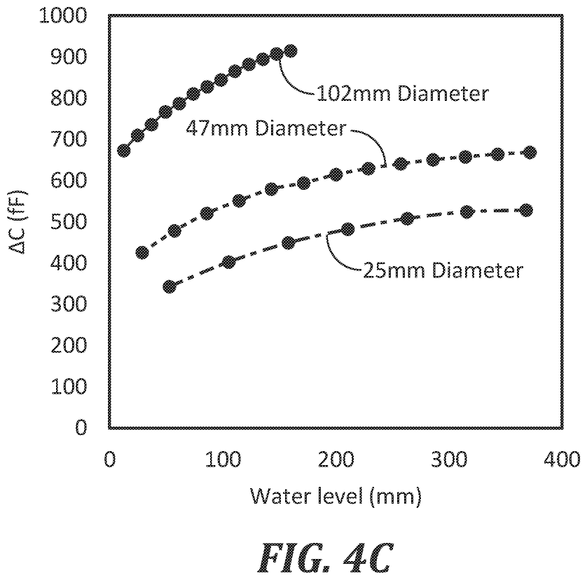

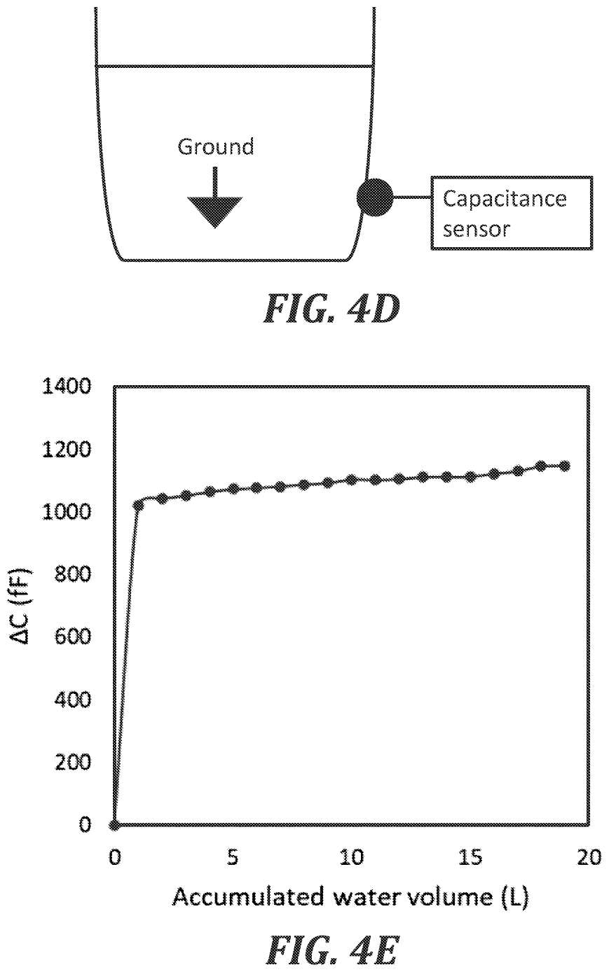

FIGS. 4A-4B are example experimental setups, in accordance with the present technology. Since a single electrode was applied for capacitive measurement, the excitation voltage was applied to the fibrous CPC electrode. The sensing electrode was located at a U-shape pedestal. The distance of the excitation electrode and the container was 1 mm in order to avoid the direct contact and the interfacial effect. Since the fibrous electrode had conductivity of 1 S/m, the resistance decreased upon pressure, which in turn increased the capacitance value. The air gap could negate the unpredictable interfacial effect. The ground electrode was present only on a capacitance chip that was 100 mm distant from the sensor.

FIG. 4C is a graph of the change in capacitance compared to the water level based on the setup of FIG. 4A, in accordance with the present technology. On the vertical axis is the change in capacitance in fF. On the horizontal axis is the water level in millimeters (mm). Shown are multiple diameters of containers used (25 mm, 47 mm, and 102 mm). As shown in FIG. 4C, the larger the container, the higher the change in capacitance measured.

FIG. 4D is an example ground location of the capacitance sensor in the liquid, in accordance with the present technology. The location of the ground may vary depending on the permittivity of the system, the liquid value, and the geometry. Moving the ground may alter a penetration depth of the capacitance sensor. The penetration depth may be controlled by varying frequencies and voltage magnitudes with the capacitance sensor.

FIG. 4E is a graph of the change in capacitance based on the volume of water in the container, in accordance with the present technology. On the vertical axis is the change in capacitance in fF. On the horizontal axis is an accumulated water volume in liters (L).

The measurement circuit consisted of a capacitance to digital converter (CDC). A CDC chip (Analog Device, AD7747) generated the excitation frequency of 16 kHz to measure the capacitance. The chip offered a high resolution of 0.1 fF. Also, the capacitive chip allowed the capacitance measurement using a single electrode. Using two sensors, differential measurement was conducted to measure the capacitance of a sensing electrode in comparison to a reference electrode. For an initial test, single-ended configuration was used to test the capacitance change in comparison to the numerical study. Differential measurements were employed to obtain the more accurate capacitive measurement with canceling the environmental interference. The sampling rate of the AD7747 converter was 45 Hz, which was averaged to obtain reliable capacitance values.

To validate the numerical study results, the experimental setup was constructed to resemble the numerical model. Using a 3D printer, the various diameters of containers with the same height were printed to measure ΔC depending on the bottom liquid area. In the tests, a single-ended configuration was used. The capacitance of each printed cup was measured under two conditions, without water and with a certain volume of water that could fill the cup to the level of 2 mm. Then the ΔC of the experiment with and without water was obtained and compared to the ΔC in the numerical study.

A 30 mm inner diameter glass beaker was employed to compare the simulation result for liquid level detection. In this test, two kinds of electrode were considered, one was the fibrous CPC sensor. The other electrode was a copper plate with the same area of 5×5 mm². The comparison between CPC and copper electrodes could give information about the role of fibrous electrodes. ΔC was measured for each electrode for the same beaker and water volume.

A set of various radius cups (3, 4, 5, 6, 7, and 8 mm) were fabricated to measure ΔC by filling with the small volume of water. 100 μL was added to the cups by each step until the total volume became 1 mL. Also, four diameter glass beakers (25, 47, 72, and 102 mm) were used for a larger volume glass beakers.

The same volume of water was dropped on a glass plate and a Teflon plate to observe ΔC. Teflon was chosen because a water drop was pinned without spreading due to its hydrophobicity. However, the drop could spread on hydrophilic glass surface. Since both Teflon and glass were nonconductive, ΔC could be induced by the water area facing to the sensor. Before experiment, the base capacitance value of each plate was measured as C₀. Water was dispensed by the four steps of water drops. The capacitance of each step was measured and subtracted by C₀ to obtain the ΔC. After the first water drop of 100 μL, three more 10 μL drops of water were sequentially added to the original drop. The results were compared for Teflon and glass plates.

ΔC values of different liquid or solutions were compared to test the sensitivity to dielectric constants. Since the dimension and the volume of liquid increased ΔC, the differential configuration using two capacitive sensors was employed. Two fibrous CPC sensors were placed with 30 mm-distance to alleviate the electric field interference. The whole measurement setup was enclosed in a grounded box in order to reduce the external noise. In the configuration, a control sensor was covered by the reference cup while the liquid on a sensing electrode was replaced. ΔC values were measured for various liquid volumes.

To proceed with the differential measurement, the first critical issue was whether the reference container should be filled with liquid or not. Two sets of tests using non-conductive cups were conducted; one was using an empty cup as reference and the other was the cup filled with water. The sensing cup for the two sets started with empty and followed by adding 5 steps of 100 μL-water. Standard deviation of each step was calculated and compared.

The 1 mL cylindrical glass vials were used for testing liquids. Since the capacitance was sensitive to geometry and location, the same holders of the vials were fabricated and attached to the stage, which was in the middle of the electrically grounded box. Initially, water was used to test the error of ΔC for differential measurement. Subsequently, the bottle on a sensing electrode was replaced with the same volume of 5M NaCl solution, acetone, and isopropanol. Furthermore, the volume fraction of alcohol in water was changed to measure ΔC to test the sensitivity. A series of alcohol fraction solutions between 0 and 20% were tested in comparison to water.

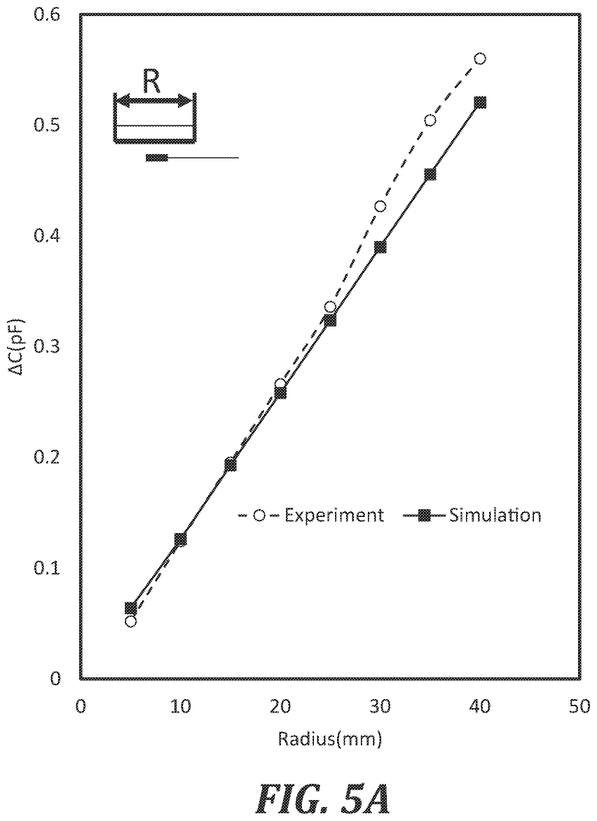

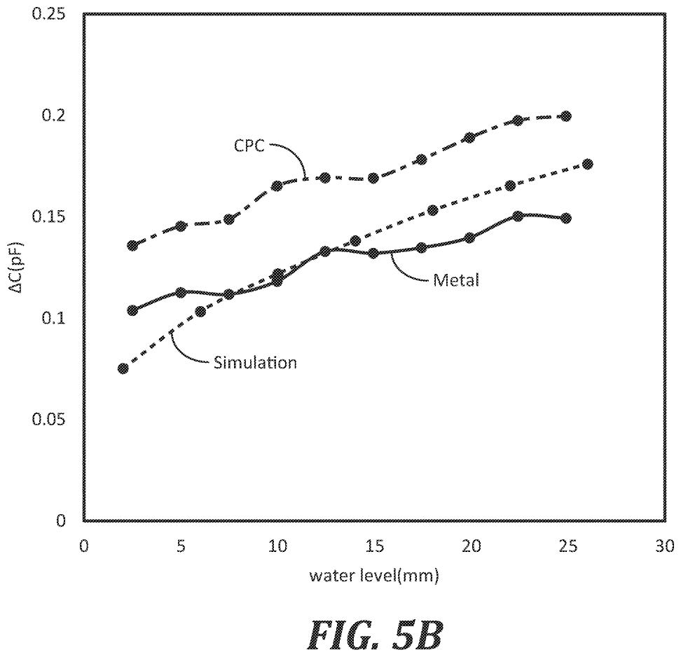

FIGS. 5A-5B are graphs showing the capacitance change with respect to a liquid dimension change, in accordance with the present technology. FIG. 5A shows the change in capacitance (ΔC) in pico-Farads (pF) on the vertical axis, and the radius of the container in millimeters (mm) on the horizontal axis. FIG. 5B shows the ΔC in pF on the vertical axis, and the water level in mm on the horizontal axis.

Both bottom and side areas of the container increased ΔC when water was introduced. The bottom area dominated ΔC, meaning that the initial introduction of water increased ΔC significantly due to the charge transfer to the initial water volume. FIG. 5A compares the ΔC of different diameter cups with the same liquid level of 2 mm. Every point was calculated by subtracting the capacitance value in the water-supplied cup by that of an empty cup. The experimental results agreed well with the simulation results. Based on the figure, ΔC was proportional to the cup diameter at the fixed water level of 2 mm. If the entire bottom surface was not covered with water, ΔC was affected by the drop shape.

FIG. 5B displayed the relationship between ΔC and the liquid level with a 30 mm diameter-bottom surface. In this test, two types of sensors made of fibrous CPC and copper plate were used to compare ΔC under the same condition. As more liquid was supplied to the container, the slopes of ΔC increased for both electrodes were almost the same. However, the initial offset ΔC for a CPC sensor was greater due to the higher electric field of the fibrous CPC electrodes. Through the simulation, the ΔC for each step of level increment became slightly smaller as the absolute liquid level became higher.

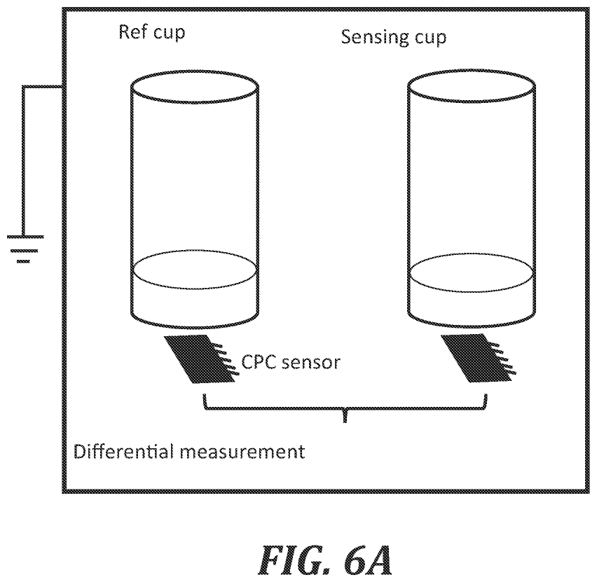

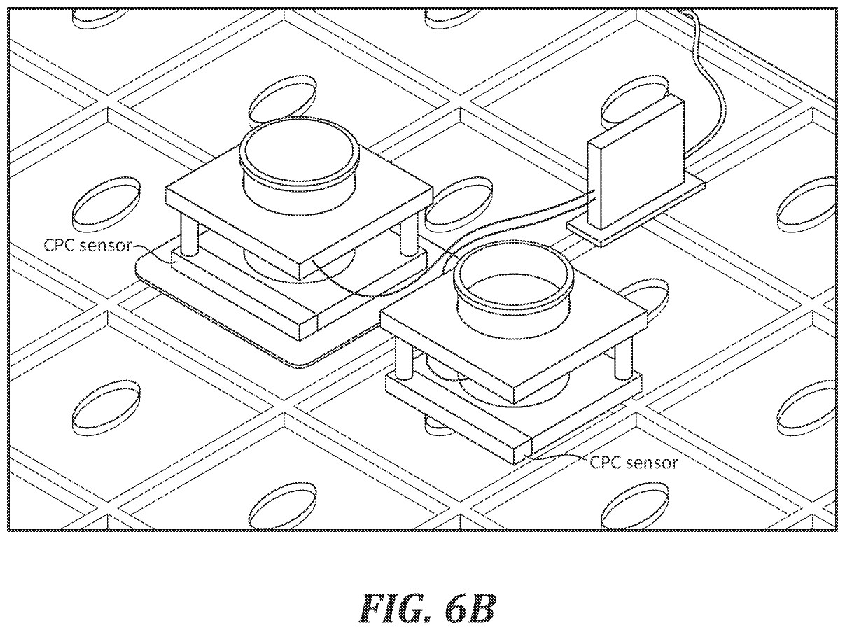

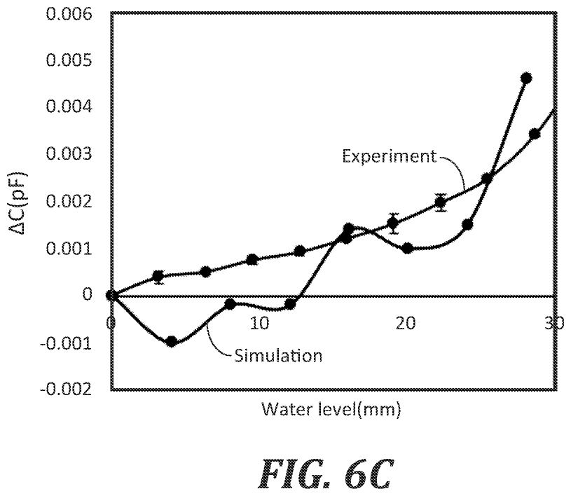

FIG. 6A is an example differential measurement system for measuring a liquid level, in accordance with the present technology. For a conductive container, stainless-steel cups were used. As given in the numerical study, the ΔC with and without water was only a few femto-Farads (IF). The differential measurement setup showed peak-to-peak noise capacitance below 0.2 fF. An experiment having the same set up was then performed.

FIG. 6B is a graph of the comparison of simulation and experimental results, in accordance with the present technology. On the vertical axis is the ΔC in pf. On the horizontal axis is the water level in mm. Compared to the non-conductive container, the C₀ value (i.e., initial capacitance) for a stainless-steel cup was much higher than that of the polylactic acid (PLA) cup. In the numerical study, ΔC for the water level below 20 mm fluctuated due to numerical errors. In experiment, the differential configuration was able to measure the ΔC by cancelling the environmental disturbance using the reference sensor. The experimental results showed a quadratic increase of ΔC by only 4 fF for a change of 30 mm-water level. Overall, the electrical path was not significantly affected in a conductive container while the liquid in a nonconductive container changed the electric field distribution and worked as a second electrode.

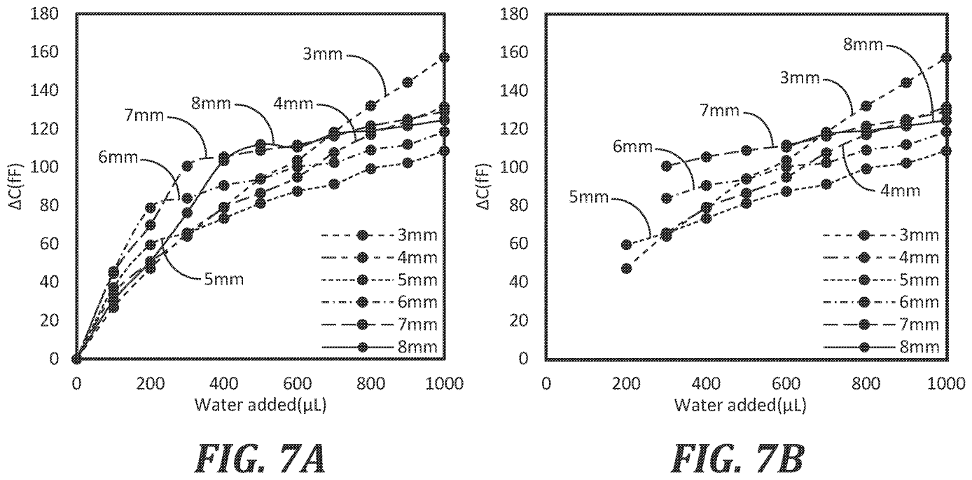

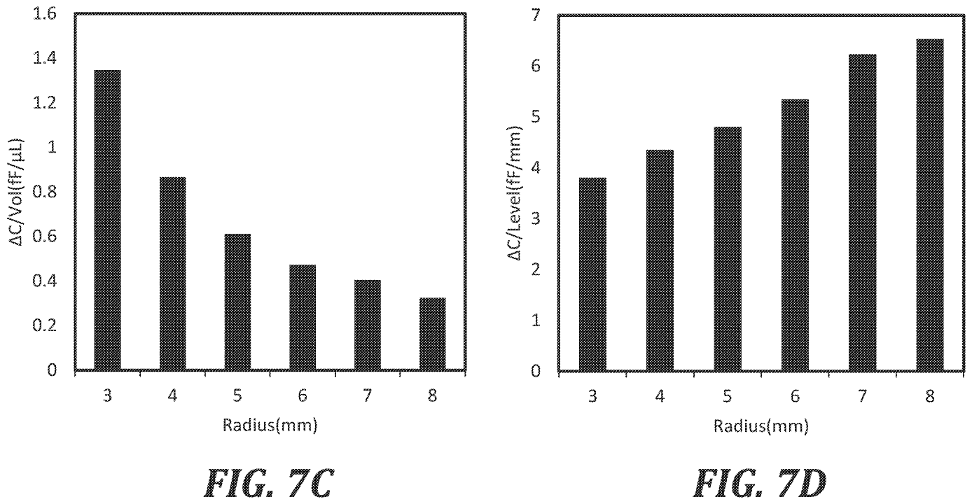

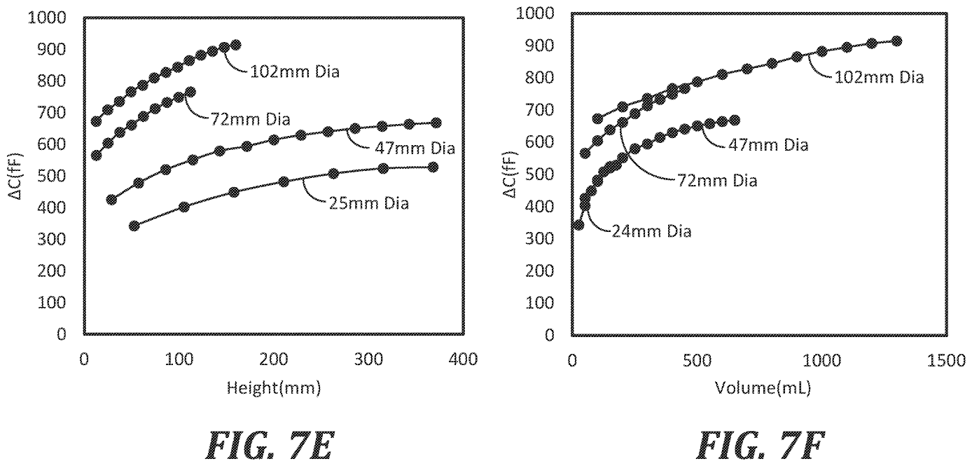

A set of sequential diameter cups (3, 4, 5, 6, 7, and 8 mm) were examined to determine the empirical model for the relationship between ΔC and liquid levels in the single electrode sensing system. FIG. 7A is a graph of the capacitance change of various nonconductive cups with respect to volume change, in accordance with the present technology. On the vertical axis is ΔC in pf and on the horizontal axis is water added in μL. FIG. 7A shows the result of ΔC for all different diameter containers with respect to the same liquid volume of 100 μL each step. It was found that each curve consisted of two linear lines with varying slopes. ΔC was changed by the two steps of electric field changes due to liquid supply. When water drops covered the entire bottom surface of the cup, ΔC increase was significant. As the water level increased, the linear increase of ΔC was observed. Since the larger diameter cups required the larger water volume to fill the bottom surface, the transition point of the larger diameter cups was delayed in comparison to that of the small cups.

FIG. 7B is a graph capacitance change for volume change after filling the bottom area, in accordance with the present technology. On the vertical axis is ΔC in pf and on the horizontal axis is water added in μL. FIG. 7B is a truncated version of FIG. 7A after the transition point according to the liquid level. Due to the various cup diameters, the ΔC slope with respect to volume was different. The ΔC of a 3 mm-diameter cup was the largest among all the cups because the water level increase for the same volume of 100 μL was the largest.

Based on the experimental results, the sensitivity with respect to the liquid volume and the liquid level were computed as shown in FIGS. 7C-7D. FIG. 7C is a graph of sensitivity of single electrode CPC sensor in terms of liquid volume for various radius non-conductive containers, in accordance with the present technology. On the vertical axis is ΔC per volume (Vol) in fF/μL. On the horizontal axis is the radius of the container in mm. FIG. 7D is a graph of sensitivity of single electrode CPC sensor in terms of liquid level for various radius non-conductive containers, in accordance with the present technology. On the vertical axis is ΔC per level in fF/mm. On the horizontal axis is the radius of the container in mm. If the liquid volume was the target parameter, then a high aspect ratio cup was better for a higher sensitivity. Using a 3 mm-diameter cup, the sensitivity was 1.36 fF/μL. A large diameter container was a better choice to measure the liquid level. The sensitivity of an 8 mm-diameter cup was 6.5 fF/mm. Considering the noise level of the capacitive sensor 0.2 fF, the resolution of liquid level detection was 31 μm.

For the testing of large glass beakers, FIGS. 7E-7F show the ΔC with respect to liquid level and the added water volume. FIG. 7E is a graph of capacitance change with respect to liquid level for large diameter beakers, in accordance with the present technology. On the vertical axis is ΔC in fF. On the horizontal axis is height in mm. FIG. 7F is a graph of capacitance change with respect to liquid volume for large diameter beakers, in accordance with the present technology. On the vertical axis is ΔC in fF. On the horizontal axis is volume in mL. Unlike the smaller containers, the relationship was no longer linear when the liquid exceeded 100 mm. With the increase of water level, the ΔC continuously increased but the increment could be reduced as expected from the simulation. This ΔC decay was more obvious when the liquid level passed 100 mm. When the level was beyond 400 mm, ΔC increase was almost negligible, which gave the approximate dynamic range. A smaller diameter container offered the higher resolution in terms of volume measurement.

The model based on the 1 mm wall thickness small diameter non-conductive container was computed to predict the liquid level through the known dimension of the cup and the corresponding ΔC in Equation 3:

$$Water level = \frac{Δ C}{( 5.663 * R + 2.06 )} \qquad Equation ( 3 )$$

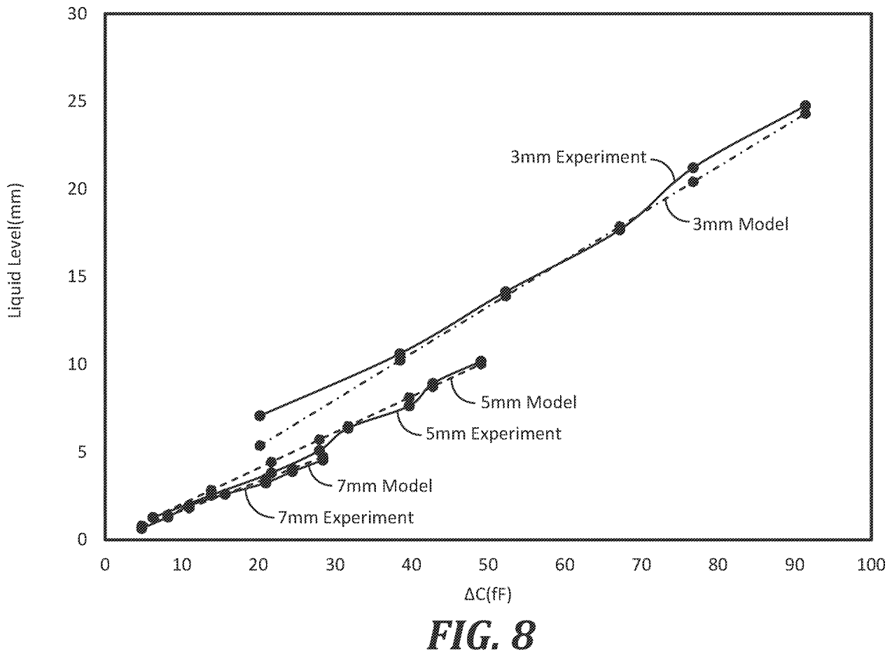

The results of the prediction based on the experiments were computed and compared for 3, 5, and 7 mm-radius containers as shown in FIG. 8. FIG. 8 is a graph of the comparison of the results of the empirical model and experiments, in accordance with the present technology. From the comparison, the empirical equation could predict the liquid level. Note that this model could be applied to specific geometry containers with controlled electric interference. Further characterization and calibration were required for different geometry and electrical environments.

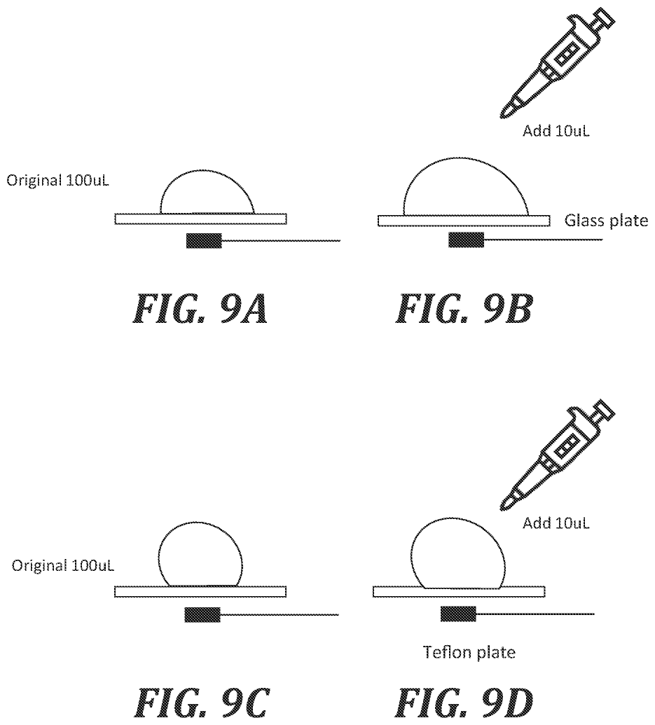

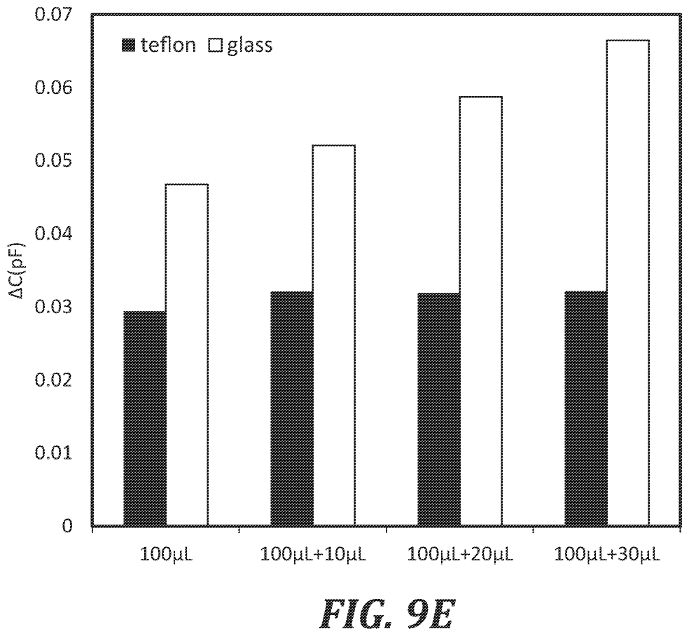

The capacitive response signals for the same volume of water drop on glass and Teflon plates were compared. FIGS. 9A-9D are process diagrams of testing glass and Teflon plates by adding water droplets, in accordance with the present technology. Because of the hydrophobic Teflon, the drop was hinged to limit the horizontal area. However, the water on the hydrophilic glass plate could expand randomly, which enlarged the facing area to the sensor.

FIG. 9E is a graph of the comparison of capacitance changes of the glass and Teflon plates of FIGS. 9A-9D, in accordance with the present technology. On the vertical axis is the ΔC in pF. On the horizontal axis is the increased water level in μL, based on the water drops. Based on the result in FIG. 9E, the ΔC for the same volume of water on glass plate was greater than that on Teflon plate. After the first drop, three additional drops of 10 μL water increased ΔC continuously for a glass plate while ΔC increase was negligible on a Teflon plate. It was concluded that the majority of ΔC was contributed by the surface area of the liquid.

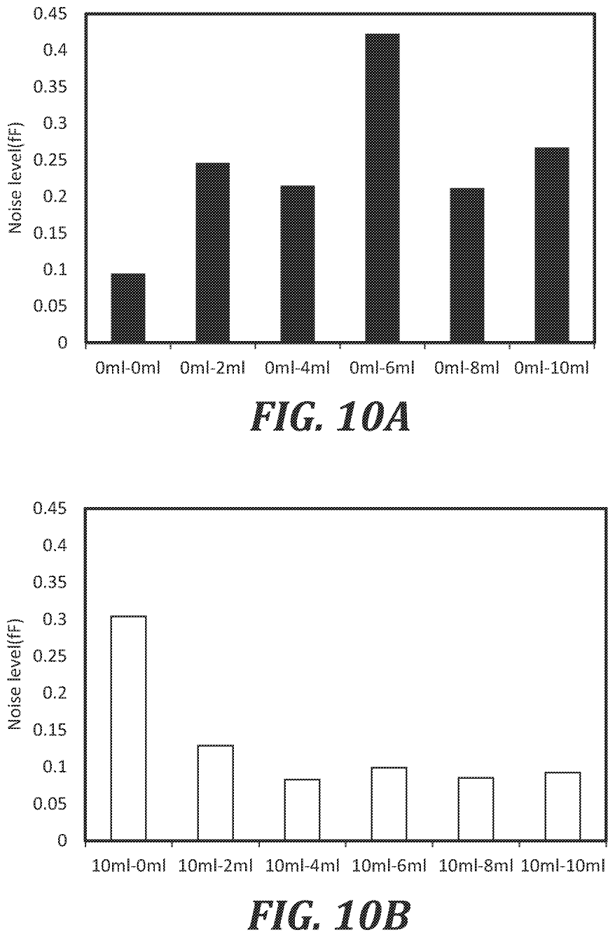

ΔC between the sensor and the reference signals was plotted in FIG. 10. For the empty bottle as reference, the noise level was higher than 0.2 fF. When using filled container as reference, the noise level could maintain at the range around 0.1 fF, unless the sensing container was empty.

FIGS. 10A-10B are graphs of characteristics of the noise level of using an empty cup (FIG. 10A) and a water filled cup (FIG. 10B) as reference in differential measurements, in accordance with the present technology. On the vertical axis of each is the noise level in fF. On the horizontal axis of each is the change in water level in ml. For capacitive sensing for liquid detection, the liquid level could be measured by a single electrode CPC sensor at the container bottom. In the tests, if the container was made of non-conductive materials, ΔC could be determined by the horizontal and vertical area that was covered with liquid. ΔC was proportional to the area increase. ΔC on the vertical water level was more predictable than that on horizontal direction because the side area change was constant when the volume of additional water was constant. The sensitivity of the sensor described herein on liquid level detection was programmable because the slope varied based on the container diameter. Therefore, the design parameter for a container could be proposed to determine the shape in order to improve the capacitive sensitivity.

The liquid detection in conductive containers were also modeled and tested in experiment. The sensitivity of the sensor was dampened by metal container. Since ΔC was in fF range, even the small disturbance of the test environment, the sensor, and liquid could affect ΔC. To improve the accuracy and the stability of the measurement, the differential configuration and a well confined test stage were used.

The differential measurement was applied in a liquid level sensing system that consisted of three parts, tubing with LED indicator, reservoir with LED graduation indicator, and as the reference tubing and reservoir. The system was designed to turn on a green LED, when liquid passes through a tube. As the reservoir filled from transported liquid, the LED graduation lights turned on with respect to the supplied liquid volume.

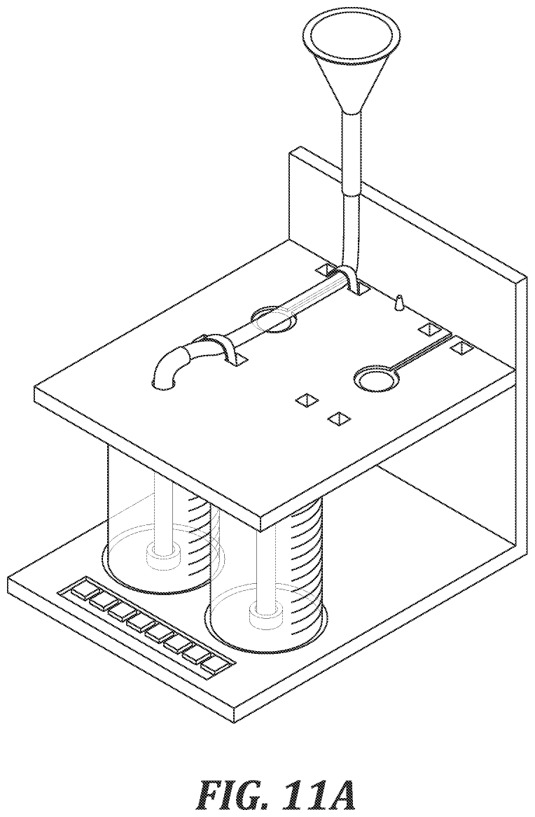

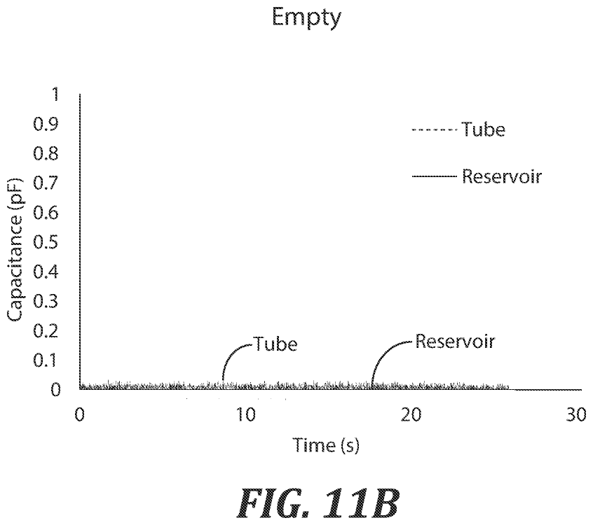

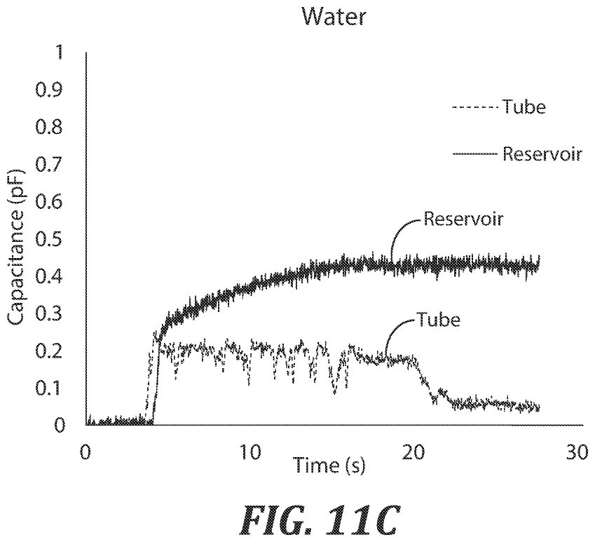

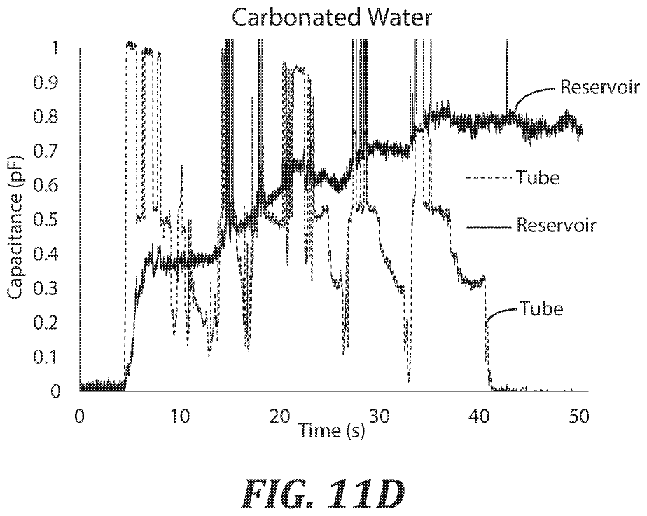

FIG. 11A shows a system set up for two differential measurements for measuring liquid level, in accordance with the present technology. To construct two differential measurements in one system, 4 CPC capacitive sensors were arranged to construct two pairs of measurements; one was for flow in the tube and the other was for the liquid level in the reservoir. The sensors were separated from the tube and reservoir by 1 mm. A funnel was used to supply the liquid into the tube. A microprocessor was connected to FDC1004 to collect the capacitance data and control LEDs. The demonstration test was conducted by the following steps: (1) 30 ml of water was supplied into the funnel. (2) As water passed through the tube, the green LED indicator was turned on to show the water flow. (3) Water was supplied to the beaker from the outlet of the tube. 4. As the beaker was gradually filled with water, the LED was turned on. As the water level increased, the LED strip sequentially turned on with respect to the water level. The data of the tube and reservoir were recorded. Besides the water, also recorded was data for empty and carbonated water, which gave more insights of the system capability.

FIGS. 11B-11D are graphs showing the results of the three test sets, in accordance with the present technology. On the vertical axis is the capacitance in pF. On the horizontal axis is time in seconds. The empty case (FIG. 11B) shows that the capacitance value of the two pairs of differential measurements were steady with low noise. In the test of water, reservoir started to capture the ΔC by a few second delay in comparison to the tube (FIG. 11C). As more water was supplied to the funnel, the ΔC on the beaker increased while the ΔC of tube kept around 200 fF. As for the carbonated water, the high concentration of bubbles created spikes in the ΔC (FIG. 11D). The tube indicator was able to be turned on by flowing carbonated water and the ΔC of the reservoir still accumulated. However, the ΔC was greater than pure water. The carbon dioxide gas bubbles showed the spikes of ΔC.

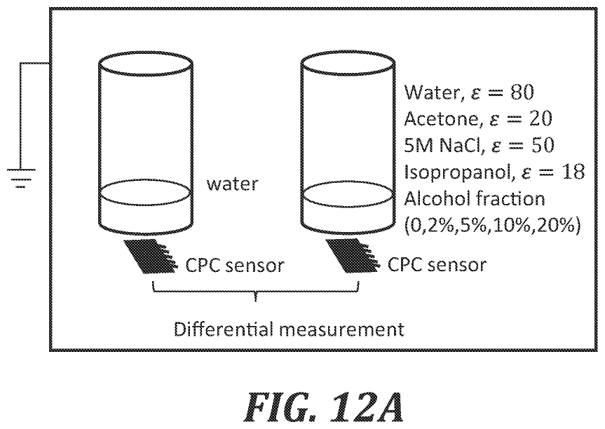

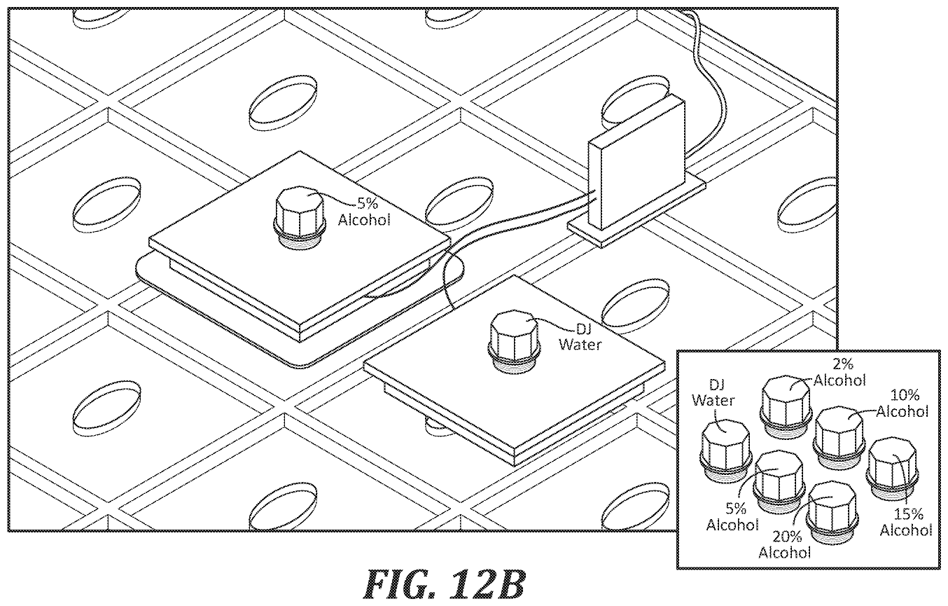

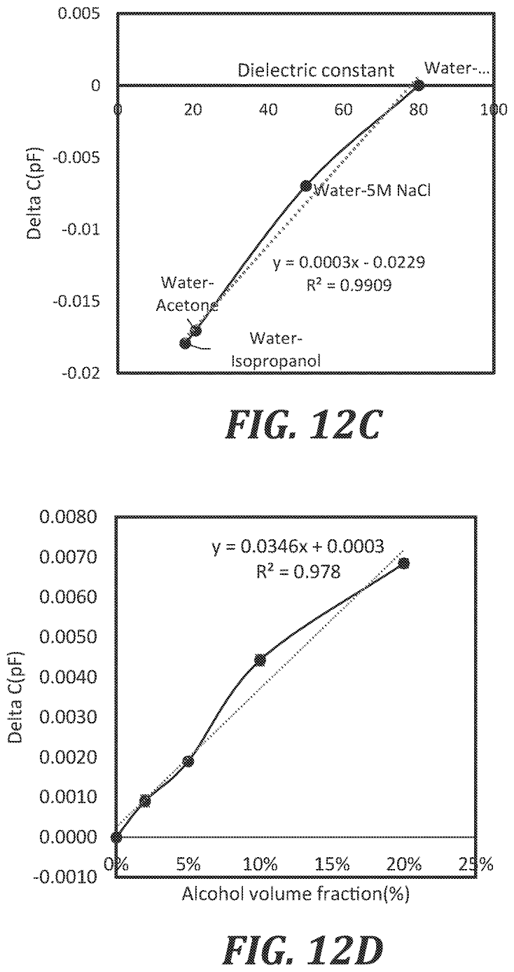

FIG. 12A is an experimental configuration of a system for measuring a liquid level, in accordance with the present technology. FIG. 12A shows the schematic diagram for the measurement setup.

FIG. 12B is an image of the experimental configuration shown in FIG. 12A, in accordance with the present technology. FIG. 12B shows the experiment setup about how the differential capacitance of two liquids was measured. Two test sets were conducted. One was to investigate how the different liquid content could be detected by the differential measurement setup. The other was to discover the reaction from the same content but various volume fraction.

FIG. 12C is a graph of the ΔC with respect to liquid contents, in accordance with the present technology. On the vertical axis is the ΔC in pF. On the horizontal axis is the dielectric constant. FIG. 12C describes the ΔC difference with respect to the dielectric constant of the specific liquid. All the liquids were filled into identical containers with the volume of 1 mL. The water-to-water comparison was first tested to understand the noise level. From the result, the ΔC was larger as the dielectric constant discrepancy between two liquids diverged. Meanwhile, the result also indicated that the ΔC was proportional to the dielectric constant of the liquid for the same geometry and same volume.

FIG. 12D is a graph of the ΔC with respect to the alcohol volume fraction, in accordance with the present technology. On the vertical axis is the ΔC in pF. On the horizontal axis is the alcohol volume fraction in percentage. FIG. 12D depicts the ΔC change and the volume fraction of alcohol. Similar to the previous test, the 0% alcohol solution was compared first to calibrate the measurement. As more alcohol added to the solution, the ΔC increased accordingly and linearly. Since the dielectric constant was reduced by the alcohol, the relationship could be modeled to calculate the volume fraction of the alcoholic solution. In comparison to the noise level, the resolution was 1%-alcohol.

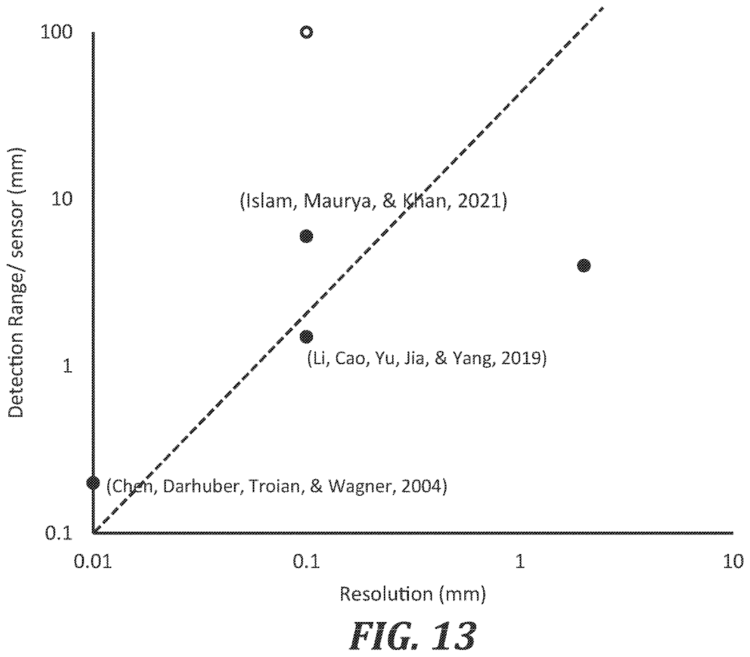

The self-capacitive single electrode sensor made of carbon nanotube composite (CPC) was demonstrated to detect the liquid level in a dynamic range of 400 millimeters because the supplied liquid worked as the second electrode for capacitance. For non-conductive containers, the relationship between the ΔC and the container dimension was studied to understand how to design the container depending on the target parameter of volume and level. Overall, a high aspect ratio container showed the better sensitivity for liquid volume measurement. To obtain a higher resolution of liquid level, a larger diameter container was preferred. In comparison to single-ended configuration, the differential configuration consisting of two single electrode sensors improved the signal to noise ratio. The liquid level detection of conductive containers was studied through differential measurement. The experimental result showed a stable and predictable capacitance change ΔC at each test level. FIG. 13 is a graph of the comparison of the resolution and detection range of the presented capacitive sensor in comparison to other capacitive sensors. The sensitivity of liquid volume and level for non-conductive containers was described in the following Table. 1 and plotted in FIG. 13 in which the sensor described herein was compared to other capacitive liquid detection sensors. In terms of the resolution and dynamic ranges, the presented sensors showed the highest detection range per sensor without compromising the sensitivity. With the differential configuration, the resolution was 0.2 mm and the dynamic range was 100 mm/sensor. The presented single electrode CPC sensor showed the potential for non-contact liquid level sensing in various applications.

TABLE 1
Comparison of the performance of the capacitive sensors using in liquid level detection.

| | Electrode | Electrode | Number of | | | Dynamic | | |
|---|---|---|---|---|---|---|---|---|
| Reference | width | spacing | electrodes | Placement | Resolution | range/sensor | Sensitivity | |
| Ex. 1 | 2 mm | 1 mm | 7 | Lateral | 0.1 mm | <6 mm | 40 | fF/mm |
| Ex. 2 | 2 mm | 2 mm | 75 | Lateral | 2 mm | <4 mm | 70 | pF/mm |
| Ex. 3 | 0.1 mm | 0.06 mm | 2 | Bottom | 0.01 mm | <0.2 mm | 30 | fF/μm |
| Ex. 4 | 10 mm | 6 mm | 2 | Bottom | 0.1 mm | <1.5 mm | 450 | fF/mm |
| This | 5 mm | x | 1 | Bottom | 0.1 mm | <100 mm | 2 | fF/mm |
| paper | | | | | | | | |

In yet another aspect, disclosed herein is a system for measuring a capacitance of a liquid, including a surface configured to contact the liquid, a sensor including a single electrode applied with positive potential, a composite substrate comprising a template material, wherein the template material including a plurality of insulating fibers, and a plurality of carbon nanotubes bonded to the insulating fibers forming a nanotube coating on the insulating fibers; where one edge of the composite substrate is torn, induced by a unidirectional tensile force to the composite substrate, where the plurality of insulating fibers align along the tensile force and expand in an out-of-plane direction at the site of the tear, and where the single electrode is coupled to the nanotube coating at the site of the tear, such that an electrical signal passes through the plurality of junctions at the site of the tear, and where self-capacitance is formed between the single electrode and an environmental ground, and where when the liquid contacts the surface, the sensor senses a change in capacitance.

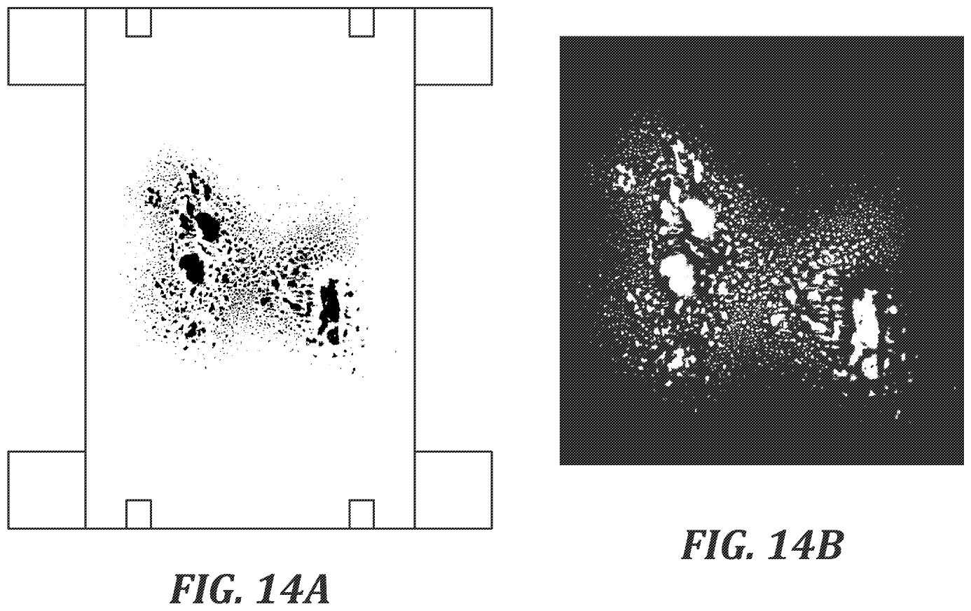

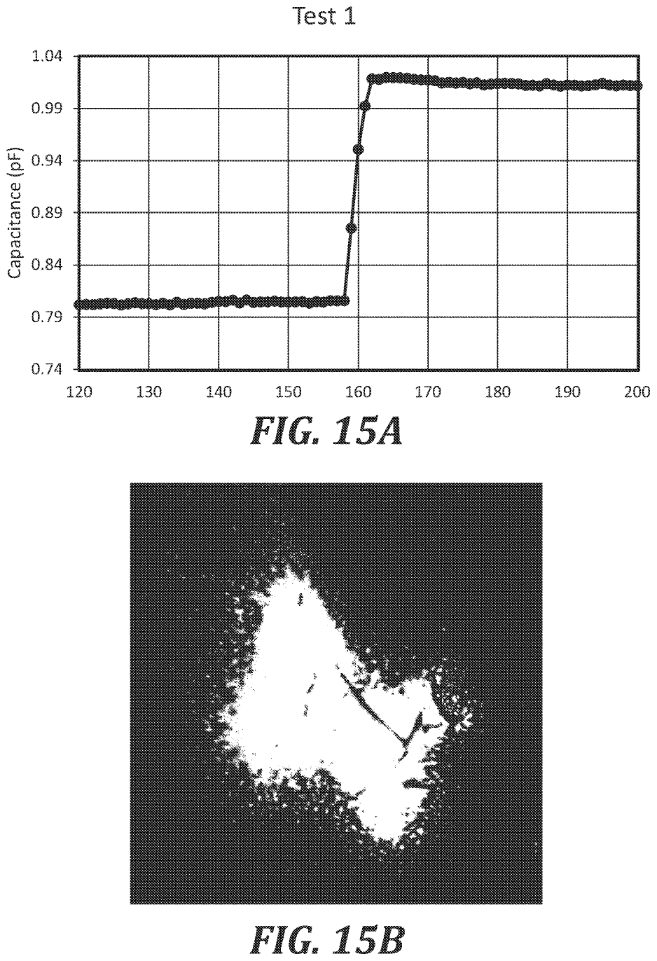

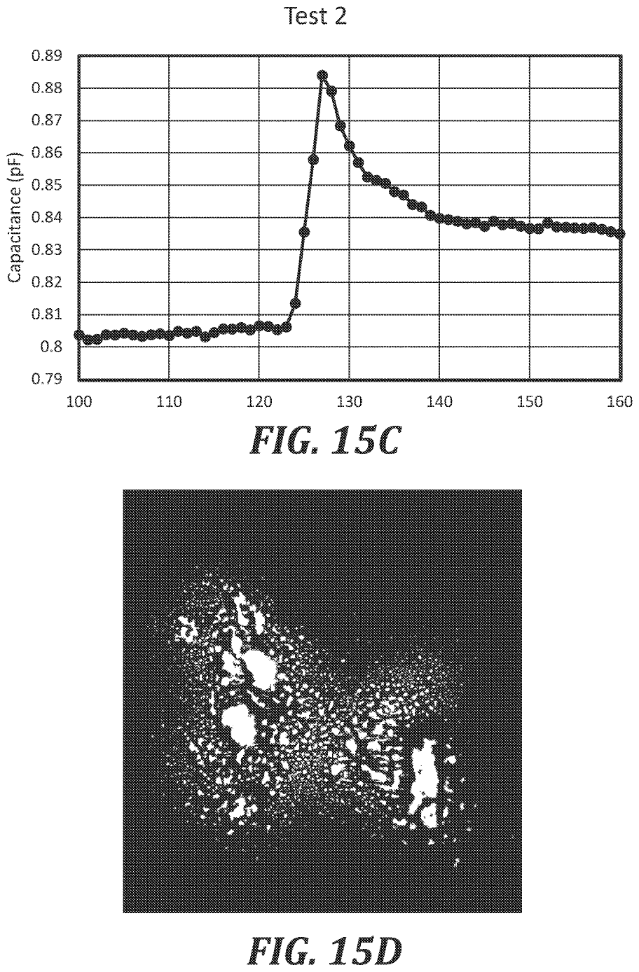

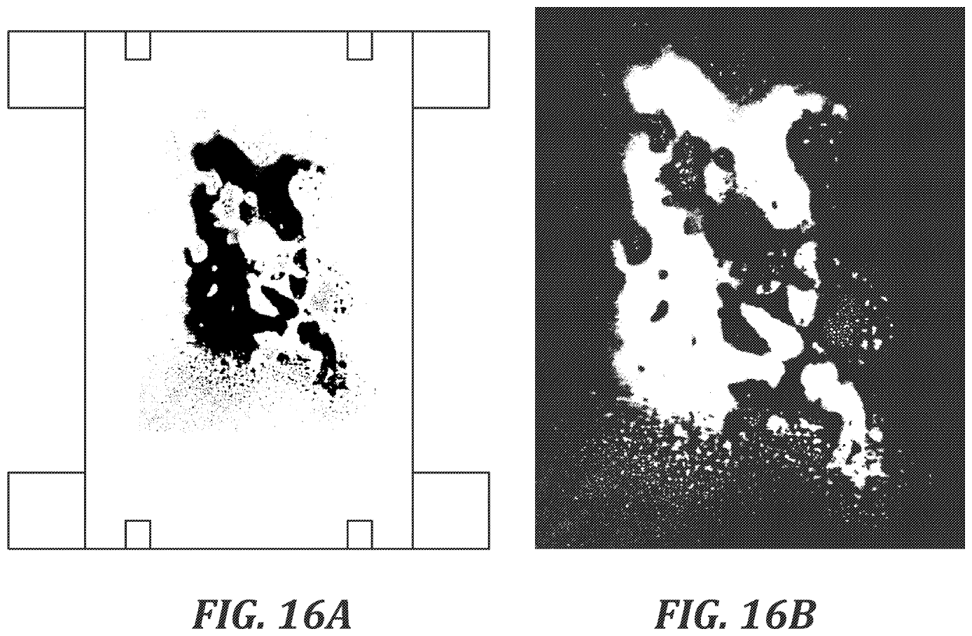

In some embodiments, the system includes a windshield coupled with a single sensor as described herein FIGS. 14A-14B are images of an example sprayed liquid detection system, in accordance with the present technology. A single spray of liquid is shown on the windshield in FIGS. 14A-14B. FIGS. 15A-15D show single sprays of liquid onto an example liquid detection system and the resulting capacitance, in accordance with the present technology. FIG. 15A is a graph of a first test, corresponding to the spray shown in FIG. 15B. On the vertical axis is the capacitance in pF. On the horizontal axis is time in seconds. FIG. 16A is a graph of a second test, corresponding to the spray shown in FIG. 15D. On the vertical axis is capacitance in pF. On the horizontal axis is the time in seconds. As shown by both FIGS. 15A and 15C, the liquid detection system was able to detect when the liquid contacted the system at each spray time (about 160 seconds in FIG. 15A and about 123 seconds in FIG. 15C).

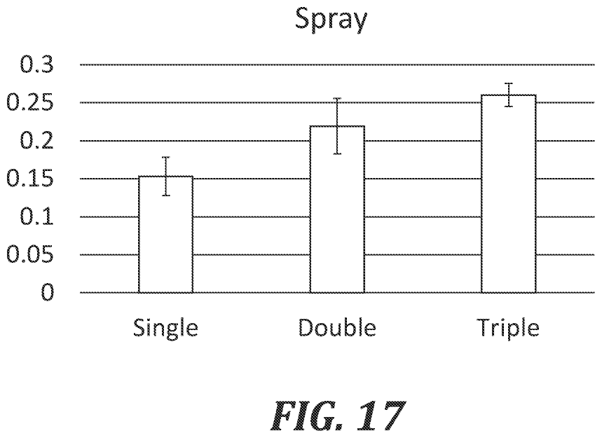

FIGS. 16A-16B are images of an example liquid detection system with multiple sprays of liquid on it, in accordance with the present technology. FIG. 17 is a graph of the capacitance measurements of multiple sprays on the windshield liquid detection system, in accordance with the present technology. On the vertical axis is capacitance in pF. On the horizontal axis is the number of sprays (single spray, double sprays, triple sprays). The capacitance increased as each spray was applied to the windshield.

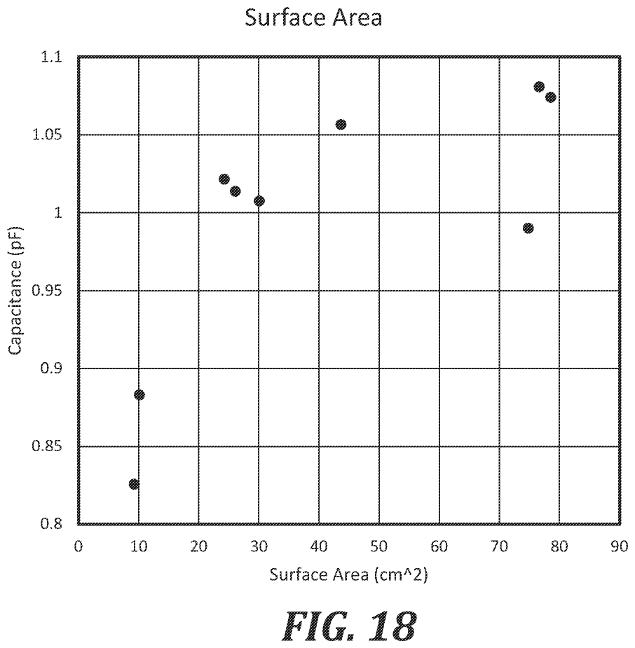

FIG. 18 is a graph showing volume response versus surface area response of multiple sprays on the windshield liquid detection system, in accordance with the present technology. On the vertical axis is the capacitance in pF. On the horizontal axis is surface area in cm². Capacitance change increased as surface area increased.

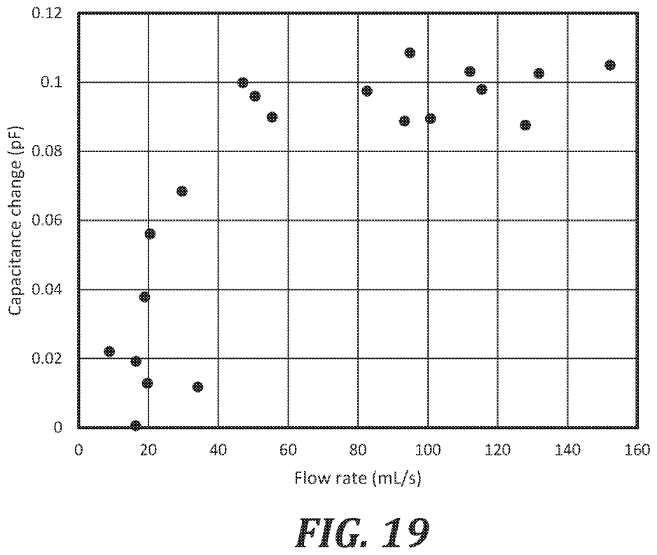

FIG. 19 is a graph of the flow rate of the sprays compared to the change in capacitance of multiple sprays on the windshield liquid detection system, in accordance with the present technology. The flow rate increased with increased capacitance value.

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A system for measuring a capacitance of a liquid, the system comprising:
a container configured to hold the liquid; and
a sensor disposed on a first side of the container, wherein there is a separation distance between the sensor and the container, the sensor comprising:
a single electrode applied with positive potential,
a composite substrate comprising a template material, wherein the template material comprises:
a plurality of insulating fibers; and
a plurality of carbon nanotubes bonded to the insulating fibers forming a nanotube coating on the insulating fibers;
wherein one edge of the composite substrate is torn, wherein the plurality of insulating fibers align along the tensile force and expand in an out-of-plane direction at the site of the tear; wherein the single electrode is coupled to the nanotube coating at the site of the tear, such that an electrical signal passes through the plurality of junctions at the site of the tear; and wherein self-capacitance is formed between the single electrode and an environmental ground with a fringing field.

2.-3. (canceled)

4. The system of claim 1, wherein the separation distance between the single electrode and the first container ranges from about 0.1 mm to 30.0 mm.

5. (canceled)

6. The system of claim 1, wherein the environmental ground is located inside the container.

7. The system of claim 1, wherein the environmental ground defines a penetration depth, and wherein the penetration depth is controlled by varying frequency and/or voltage magnitudes of the system.

8. The system of claim 1, wherein the system further comprises:
a capacitance to digital chip coupled to the sensor configured to generate an excitation frequency; and
a microprocessor configured to measure the capacitance.

9. The system of claim 1, wherein the sensor is immersed in liquid to measure liquid volume or liquid level.

10. The system of claim 9, wherein the sensor is coated with a nonconductive layer, wherein the nonconductive layer is configured to dampen a sensitivity and obtain a linear capacitive response.

11. The system of claim 9, wherein the sensor is disposed above the first side of the container, and wherein the first side of the container is a bottom, a side, or a top of the container.

12. The system of claim 1, wherein the sensor is configured to measure a difference of liquid permittivity.

13. (canceled)

14. A system for measuring a capacitance of a first liquid, the system comprising:
a first container configured to hold the first liquid;
a reference container configured to hold a reference liquid, wherein there is a container separation distance between the first container and the reference container;
a measurement circuit, comprising:
a first sensor disposed on a first side of the first container, wherein there is a first separation distance between the first sensor and the first container, the first sensor comprising:
a first electrode applied with a positive potential;
a first composite substrate comprising a first template material, wherein the first template material comprises:
a first plurality of insulating fibers; and
a first plurality of carbon nanotubes bonded to the first insulating fibers forming a first nanotube coating on the first insulating fibers;
wherein one edge of the first composite substrate is torn, wherein the first plurality of insulating fibers align along the tensile force and expand in an out-of-plane direction at the site of the tear; wherein the first electrode is coupled to the first nanotube coating at the site of the tear, such that an electrical signal passes through the plurality of junctions at the site of the tear; and wherein self-capacitance is formed between the single electrode and an environmental ground with a fringing field; and
a reference sensor disposed on a first side of the reference container, wherein there is a second separation distance between the reference sensor and the reference container, the reference sensor comprising:
a reference electrode;
a capacitance to digital chip convertor configured to generate an excitation frequency; and
a microprocessor configured to measure a capacitance change,
wherein the measurement circuit is configured to measure a differential capacitance measurement between the first electrode and the reference electrode.

15. The system of claim 14, wherein the reference sensor further comprises:
a second composite substrate comprising a second template material, wherein the second template material comprises:
a second plurality of insulating fibers; and
a second plurality of carbon nanotubes bonded to the second insulating fibers forming a second nanotube coating on the second insulating fibers;
wherein one edge of the second composite substrate is torn, wherein the second plurality of insulating fibers align along the tensile force and expand in an out-of-plane direction at the site of the tear; wherein the reference electrode is coupled to the nanotube coating at the site of the tear, such that an electrical signal passes through the plurality of junctions at the site of the tear.

16. The system of claim 14, wherein the first separation distance ranges from about 0.01 mm to 30 mm.

17. The system of claim 14, wherein the second separation distance ranges from about 0.01 mm to 30 mm.

18. The system of claim 14, wherein the container separation distance ranges from about 50 mm to 200 mm.

19-21. (canceled)

22. The system of claim 14, wherein a diameter of the first container ranges from about 1 mm to 1000 mm.

23-24. (canceled)

25. The system of claim 14, wherein a sensitivity of the system ranges from about 1.4 fF/μl to 20.0 fF/mm.

26. The system of claim 14, wherein a detection range of the system is about 0 to 1000 mm.

27-29. (canceled)

30. A liquid dispenser comprising:
a first reservoir configured to hold a first liquid;
a first sensor, disposed on a first side of the first reservoir, wherein there is a first separation distance between the first sensor and the first reservoir, and wherein the first sensor comprises:
a first electrode applied with a positive potential;
a first composite substrate comprising a first template material, wherein the first template material comprises:
a first plurality of insulating fibers; and
a first plurality of carbon nanotubes bonded to the first insulating fibers forming a first nanotube coating on the first insulating fibers;
wherein one edge of the first composite substrate is torn, wherein the first plurality of insulating fibers align along the tensile force and expand in an out-of-plane direction at the site of the tear; wherein the first electrode is coupled to the first nanotube coating at the site of the tear, such that an electrical signal passes through the plurality of junctions at the site of the tear; and wherein self-capacitance is formed between the single electrode and an environmental ground with a fringing field;
a first tubing fluidly coupled to the first reservoir;
a second sensor coupled to the first tubing;
a reference reservoir configured to hold a reference liquid;
a first reference sensor, disposed on a first side of the reference reservoir, wherein there is a second separation distance between the first reference sensor and the reference reservoir,
a reference tubing fluidly coupled to the reference reservoir; and
a second reference sensor coupled to the reference tubing,
wherein the first sensor is configured to measure a change in volume of the first liquid in the first reservoir, the second sensor is configured to measure an amount of first liquid that passes through the first tubing, the first reference sensor is configured to measure a change in volume of the reference liquid in the reference reservoir, and the second reference electrode is configured to measure an amount of reference liquid that passes through the reference tubing.

31. The liquid dispenser of claim 30, wherein the first reservoir comprises a first graduation indicator, and
wherein the reference reservoir comprises a second graduation indicator.

32. (canceled)

33. The liquid dispenser of claim 30, wherein the first liquid is a carbonated liquid, or both the first liquid and the reference liquid are a carbonated liquid.

34-66. (canceled)
